(19) United States
(12) Patent Application Publication
(10) Pub. No.: US 2017/0160833 A1
(43) Pub. Date: Jun. 8, 2017

(54) CAPACITIVE TOUCH PANEL AND CAPACITIVE TOUCH APPARATUS HAVING THE SAME

(71) Applicant: LEADING UI CO., LTD., Anyang-si, Gyeonggi-do (KR)

(72) Inventor: Sang-Hyun HAN, Anyang-si, Gyeonggi-do (KR)

(21) Appl. No.: 15/321,019

(22) PCT Filed: Jul. 4, 2014
(86) PCT No.: PCT/KR2014/006008

§ 371 Date: Dec. 21, 2016

(30) Foreign Application Priority Data
Jun. 23, 2014 (KR) 10-2014-0076652

(51) Int. Cl. G06F 3/044

(52) U.S. Cl. CPC G06F 3/044; G06F 2203/04104

(57) ABSTRACT

It is disclosed that a capacitive touch panel that achieves a multi-touch in a single layer structure to have a reduced wiring complexity in a touch area and a capacitive touch apparatus having the capacitive touch panel. A capacitive touch panel includes a plurality of main sensors and a plurality of sub-sensors. The main sensors are disposed on a touch area. The sub-sensors are disposed along one line adjacent to each of the main sensors. The sub-sensors are disposed in one-to-plural correspondence with respect to one main sensor. The sub-sensors disposed on an imaginary line vertical to a length direction of the main sensor are connected to each other.

### BACKGROUND OF THE INVENTION

Technical Field

Exemplary embodiments of the present invention relate to a capacitive touch panel and a capacitive touch apparatus having the capacitive touch panel. More particularly, exemplary embodiments of the present invention relate to a capacitive touch panel having a reduced wiring complexity in a touch area and a capacitive touch apparatus having the capacitive touch panel.

Discussion of the Related Art

Generally, a touch sensor is a device that detects the presence of an object such as a finger or stylus within a designated input area. One common form of touch sensor is a touch screen that senses the presence and position of a finger or stylus on a visual display. Such touch screens can be found in a wide variety of electronic devices such as automated teller machines, home appliances, televisions, cellular phones, portable media players, personal digital assistants, and e-books, to name but a few. Touch screens come in a variety of different forms, including resistive touch screens, surface acoustic wave touch screens, infrared touch screens, and capacitive touch screens.

A resistive touch screen comprises multiple layers of resistive material formed on a substrate such as a glass plate or a transparent plastic plate. Where an object comes in contact with the resistive touch screen, it changes an electric current across one or more of the layers, and the change of current is used to detect a touch event.

A surface acoustic wave touch screen comprises an ultrasonic wave generator that transmits ultrasonic waves across a surface of the touch screen. Where an object approaches the surface of the touch screen, portions of the ultrasonic waves are absorbed or deflected, allowing a touch event to be detected.

An infrared touch screen comprises light-emitting diodes (LEDs) that create infrared beams across a surface of the touch screen, and photodetectors that detect the beams. Where an object approaches the surface of the touch screen, the photodetectors detect interruption of some of the infrared beams. The pattern of interrupted beams allows the infrared touch screen to detect a touch event. A capacitive touch screen comprises an insulator such as glass, and a transparent conductor such as indium tin oxide (ITO) formed on the insulator. Where an object such as a finger touches the capacitive touch screen, it distorts an electrostatic field of the conductor, which can be measured as a change in capacitance. The change of capacitance is used to detect a touch event.

Among existing touch screen technologies, resistive touch screens are among the most common because of their relatively low price. One drawback of resistive touch screens, however, is that they typically can sense only one touch event at a time. Accordingly, as research is conducted on multi-touch user interfaces, capacitive touch screens are gaining popularity.

A connection wiring for connecting a capacitance measuring circuit and a touch sensor may be generally manufactured by printing a conductive ink containing silver particles or by evaporating a wiring of a metallic material, so that a touch screen device is manufactured. Touch resolution increases, it is possible to increase the number of the connection wirings. Particularly, a large number of connection wirings are disposed on a touch area, thereby increasing a wiring complexity to decrease touch sensitivity.

### SUMMARY

This aspect of the present invention is conceived to solve the problems of the prior art, an object of the present invention is to provide a capacitive touch panel achieving a multi-touch in a single layer structure to have a reduced wiring complexity in a touch area.

Another object of the present invention is to provide a capacitive touch panel reducing a distortion of measured touch time by compensating a resistance difference between two end terminal of a touch sensor and a capacitive touch apparatus to accurately measure a touch position.

Another object of the present invention is to provide a capacitive touch apparatus having the above-mentioned capacitive touch panel.

According to one aspect of the present invention, a capacitive touch panel includes a plurality of main sensors and a plurality of sub-sensors. The main sensors are disposed on a touch area. The sub-sensors are disposed along one line adjacent to each of the main sensors. The sub-sensors are disposed in one-to-plural correspondence with respect to one main sensor. Here, the sub-sensors disposed on an imaginary line vertical to a length direction of the main sensor are connected to each other.

In an exemplary embodiment, the main sensor and sub-sensors disposed along one line may be alternately arranged.

In an exemplary embodiment, sub-sensors disposed in parallel with the main sensor may be only disposed along one line.

In an exemplary embodiment, the capacitive touch panel may further include a plurality of main connection wirings connected to first side of the main sensors, respectively.

In an exemplary embodiment, the capacitive touch panel may further include a plurality of sub-connection wirings connecting to sub-sensors disposed on an imaginary line perpendicular to a length direction of the main sensor.

In an exemplary embodiment, the capacitive touch panel may further include a ground member disposed between a sub-connection wiring adjacent to the main sensor and the main sensor.

In an exemplary embodiment, the main sensors and the sub-sensors may include at least one of a metal mesh, a silver nano-wire, a carbon nanotubes and indium tin oxide (ITO).

In an exemplary embodiment, a width of sub-sensors disposed at an outmost area may be substantially equal to a width of sub-sensors disposed at a remaining area.

In an exemplary embodiment, a width of sub-sensors disposed at an outmost area may be narrower than a width of sub-sensors disposed at a remaining area.

In an exemplary embodiment, the capacitive touch panel may further include a plurality of sub-bypass wirings disposed at a peripheral area to be connected to each outmost sub-sensor of the sub-sensors in one-to-one correspondence.

In an exemplary embodiment, each of the main sensors may have a bar shape, and each of the sub-sensors may have a rectangular shape.

In an exemplary embodiment, each of the main sensors may have a shape on which plural diamonds are serially connected to each other, and each of the sub-sensors may have a diamond shape.

In an exemplary embodiment, each sub-sensors disposed on the same row of sub-sensors serially connected to each other may be connected to the different ports of a capacitance measuring circuit to sense a touch position in a self-capacitance method.

In an exemplary embodiment, each sub-sensors disposed on the same row of sub-sensors serially connected to each other may be commonly connected to a capacitance measuring circuit to sense a touch position in a mutual capacitance method.

According to another aspect of the present invention, a capacitive touch panel includes a plurality of main sensors extended along a first direction of a touch area to be arranged along a second direction, and a plurality of sub-sensors arranged along the first direction in one-to-plural correspondence in parallel with the main sensors. The main sensor and the sub-sensors arranged in parallel with the main sensor are alternately arranged.

In an exemplary embodiment, the capacitive touch panel may further include a plurality of first main connection wirings connected to first sides of the main sensors, and a plurality of second main connection wirings connected to second sides of the main sensors. Here, a portion on which the first main connection wiring and the main sensor are connected to each other and a portion on which the second main connection wiring and the main sensor are connected to each other are faced to each other.

In an exemplary embodiment, each width of the sub-sensors may be gradually decreased toward a peripheral portion of the touch area from a center portion of the touch area.

In an exemplary embodiment, a slit portion may be formed through an outmost sub-sensor among sub-sensors disposed between the main sensors adjacent to each other.

In an exemplary embodiment, plural sub-sensors disposed on an imaginary line perpendicular to a length direction of the main sensor may be connected in parallel with each other.

In an exemplary embodiment, plural sub-sensors disposed on an imaginary line perpendicular to a length direction of the main sensor may be connected in serial with each other.

In an exemplary embodiment, the sub-sensors disposed between the main sensors adjacent to each other may have the same width, and each of the sub-sensors may be shifted to be disposed thereon when viewed from a plan view.

In an exemplary embodiment, plural sub-sensors disposed on an imaginary line perpendicular to a length direction of the main sensor may be connected in parallel with each other.

In an exemplary embodiment, the capacitive touch panel may further include a plurality of first sub-connection wirings, a plurality of second sub-connection wirings, a plurality of first sub-bypass wirings and a plurality of second sub-bypass wirings. The first sub-connection wirings are connected to a portion of sub-sensors arranged along the first direction and extended along an upper direction when viewed from a plan view. The second sub-connection wirings are connected to a portion of sub-sensors or the remaining sub-sensors and extended along a lower direction when viewed from a plan view. The first sub-bypass wirings are disposed on a peripheral area surrounding the touch area to be connected to each of the first sub-connection wiring in one-to-one correspondence. The second sub-bypass wirings are disposed on the peripheral area to be connected to each of the second sub-connection wiring in one-to-one correspondence.

In an exemplary embodiment, the first bypass wirings and the first sub-connection wirings may be disposed on different layers from each other.

In an exemplary embodiment, the second bypass wirings and the second sub-connection wirings may be disposed on different layers from each other.

In an exemplary embodiment, the main sensor may be disposed to sense a touch position of a first axis, and the sub-sensor may be disposed to sense a touch position of a second axis.

In an exemplary embodiment, the first axis may be at least one of a X-axis and a Y-axis, and the second axis may be a remaining axis.

In an exemplary embodiment, when it is assumed that a line which is vertical to a length direction of the main sensor and passing a center area of the main sensor is an imaginary line, the first sub-connection wiring may be connected to first and second sides of a sub-sensors disposed on an upper area with respect to the imaginary line, and the second sub-connection wiring may be connected to first and second sides of sub-sensors disposed on a lower area with respect to the imaginary line.

In an exemplary embodiment, a first side of a sub-sensor disposed on a line perpendicular to a length direction of the main sensor may be connected to the first sub-connection wiring, and a second side of a sub-sensor disposed on a line perpendicular to a length direction of the main sensor may be connected to the second sub-connection wiring.

In an exemplary embodiment, the first sub-connection wirings may be disposed between a sub-sensor connected to the first sub-connection wiring and a main sensor disposed at a left side of the corresponding sub-sensor. The second sub-connection wirings may be disposed between a sub-sensor connected to the second sub-connection wiring and a main sensor disposed at a right side of the corresponding sub-sensor.

According to another aspect of the present invention, a capacitive touch apparatus includes a capacitive touch panel and a capacitance measuring circuit. The capacitive touch panel includes a plurality of main sensors disposed on a touch area and a plurality of sub-sensors disposed along one line adjacent to each of the main sensors. The sub-sensors are disposed in one-to-plural correspondence with respect to one main sensor. The capacitance measuring circuit is respectively connected to two end terminals of the main sensors and two terminals of the sub-sensors to sense a capacitance variation of the main sensors and the sub-sensors to measure a touch position. Here, the sub-sensors disposed on an imaginary line vertical to a length direction of the main sensor are connected to each other.

In an exemplary embodiment, the capacitance measuring circuit may measure a first axis value of a touch position bases on the main sensor, and may measure a second axis value of a touch position bases on the sub-sensor.

In an exemplary embodiment, the first axis value may be a value of a Y-axis, and the second axis value may be a value of a X-axis.

In an exemplary embodiment, each sub-sensors disposed on the same row of sub-sensors serially connected to each other may be connected to the different ports of a capacitance measuring circuit to sense a touch position in a self-capacitance method.

In an exemplary embodiment, each sub-sensors disposed on the same row of sub-sensors serially connected to each other may be commonly connected to a capacitance measuring circuit to sense a touch position in a mutual capacitance method.

According to another aspect of the present invention, a capacitive touch apparatus includes a capacitive touch panel and a capacitance measuring circuit. The capacitive touch panel includes a plurality of main sensors extended along a first direction of a touch area to be arranged along a second direction and a plurality of sub-sensors arranged along the first direction in one-to-plural correspondence in parallel with the main sensors. The capacitance measuring circuit is respectively connected to two end terminals of the main sensors and two terminals of the sub-sensors to sense a capacitance variation of the main sensors and the sub-sensors to measure a touch position. Here, the main sensor and the sub-sensors arranged in parallel with the main sensor are alternately arranged.

In an exemplary embodiment, the capacitance measuring circuit may measure a first axis value of a touch position bases on the main sensor, and may measure a second axis value of a touch position bases on the sub-sensor.

In an exemplary embodiment, the first axis value may be a value of a X-axis, and the second axis value may be a value of a Y-axis.

In an exemplary embodiment, the first axis value may be a value of a Y-axis, and the second axis value may be a value of a X-axis.

In an exemplary embodiment, the capacitive touch panel may further include a plurality of main connection wirings, a plurality of second main-connection wirings, a plurality of first sub-connection wirings and a plurality of second sub-connection wirings. The main connection wirings are connected to first sides of the main sensors, respectively. The second main-connection wirings are connected to second sides of the main sensors, respectively. The first sub-connection wirings are connected to a portion of sub-sensors arranged along the first direction and extended along an upper direction when viewed from a plan view. The second sub-connection wirings are connected to a portion of sub-sensors or the remaining sub-sensors and extended along a lower direction when viewed from a plan view.

In an exemplary embodiment, the capacitive touch panel may further include a plurality of first sub-bypass wirings and a plurality of second sub-bypass wirings. The first sub-bypass wirings are disposed on a peripheral area surrounding the touch area to be connected to each of the first sub-connection wiring in one-to-one correspondence. The second sub-bypass wirings are disposed on the peripheral area to be connected to each of the second sub-connection wiring in one-to-one correspondence.

According to a capacitive touch panel and a capacitive touch apparatus having the capacitive touch panel, since main sensors, sub-sensors, main connection wirings, sub-connection wirings, first sub-bypass wirings and second sub-bypass wirings are disposed in the same plan, it may realize a capacitive touch panel of a single layer structure.

Moreover, main sensors and sub-sensors are independently connected to each other to realize a capacitive touch panel, so that it may accomplish a multi-touch.

Moreover, one main connection wiring is connected to a main sensor and sub-sensors adjacent to the main sensor are serially connected to each other to be connected to a capacitance measuring circuit, so that it may reduce a wiring complexity in a touch area.

Moreover, a capacitance measuring circuit, which is to apply a reference signal to a first side of a touch sensor and to receive a reference signal having a varied voltage due to a resistance and a capacitance formed in the touch sensor when a touch is generate through a second side of the touch sensor, is configured. A resistance difference between the capacitance measuring circuit and the touch sensor is compensated, so that it may reduce a distortion of measured touch time to accurately measure a voltage variation.

### BRIEF DESCRIPTION OF THE DRAWINGS

The above and other features and aspects of the present invention will become more apparent by describing in detailed exemplary embodiments thereof with reference to the accompanying drawings, in which:

FIG. 1 is a plan view schematically illustrating a capacitive touch apparatus according to an exemplary embodiment of the present invention;

FIG. 2 is a block diagram schematically illustrating a capacitance measuring circuit shown in FIG. 1;

FIG. 3 is a block diagram schematically illustrating a capacitance measuring circuit shown in FIG. 2;

FIG. 4 is a circuit diagram illustrating one example of a charging/discharging circuit part shown in FIG. 2;

FIG. 5 is a circuit diagram illustrating another example of a charging/discharging circuit part shown in FIG. 2;

FIG. 6 is a schematic diagram schematically explaining a capacitance sensing through a capacitive touch panel shown in FIG. 1;

FIG. 7 is a graph schematically explaining a delaying of a sensing signal along a first sensing direction and a second sensing direction shown in FIG. 6;

FIG. 8 is a schematic diagram explaining a complex switch shown in FIG. 2;

FIGS. 9A and 9B are schematic diagrams explaining a path of a capacitance sensing signal;

FIG. 10 is a plan view schematically illustrating an example of a capacitive touch panel shown in FIG. 1;

FIGS. 11A to 11C are plan views illustrating a manufacturing method of the capacitive touch panel shown in FIG. 10;

FIG. 12 is a plan view schematically illustrating another example of a capacitive touch panel shown in FIG. 1;

FIG. 13 is a plan view schematically illustrating another example of a capacitive touch panel shown in FIG. 1;

FIG. 14 is a schematic diagram illustrating a touch sensing through a capacitive touch panel shown in FIG. 1;

FIG. 15 is a plan view schematically illustrating a capacitive touch apparatus according to another exemplary embodiment of the present invention;

FIG. 16 is a schematic diagram illustrating a touch sensing through a capacitive touch panel shown in FIG. 15;

FIG. 17 is a plan view schematically illustrating a capacitive touch apparatus according to another exemplary embodiment of the present invention;

FIG. 18 is a plan view schematically illustrating a capacitive touch apparatus according to another exemplary embodiment of the present invention;

FIG. 19 is a schematic diagram illustrating a touch sensing through a capacitive touch panel shown in FIG. 18;

FIG. 20 is a plan view schematically illustrating a modification example of a capacitive touch panel shown in FIG. 18;

FIG. 21 is a plan view schematically illustrating a modification example of a capacitive touch panel shown in FIG. 18;

FIG. 22 is a plan view schematically illustrating a capacitive touch apparatus according to another exemplary embodiment of the present invention;

FIG. 23 is a plan view schematically illustrating a capacitive touch apparatus according to another exemplary embodiment of the present invention;

FIG. 24 is a plan view schematically illustrating a capacitive touch apparatus according to another exemplary embodiment of the present invention;

FIG. 25 is a plan view schematically illustrating a capacitive touch apparatus according to another exemplary embodiment of the present invention; and

FIG. 26 is a plan view schematically illustrating a modification example of a capacitive touch panel shown in FIG. 25.

### DETAILED DESCRIPTION OF THE INVENTION

The present invention is described more fully hereinafter with reference to the accompanying drawings, in which exemplary embodiments of the present invention are shown. The present invention may, however, be embodied in many different forms and should not be construed as limited to the exemplary embodiments set forth herein. Rather, these exemplary embodiments are provided so that this disclosure will be thorough and complete, and will fully convey the scope of the present invention to those skilled in the art.

In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular exemplary embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments of the invention are described herein with reference to cross-sectional illustrations that are schematic illustrations of idealized exemplary embodiments (and intermediate structures) of the present invention. As such, variations from the shapes of the illustrations as a result, for example, of manufacturing techniques and/or tolerances, are to be expected. Thus, exemplary embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

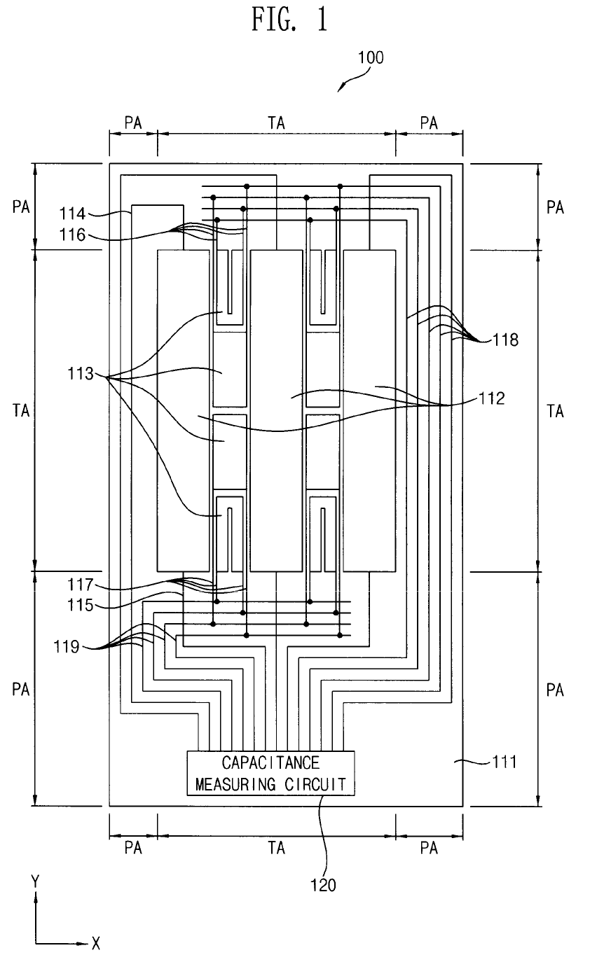

FIG. 1 is a plan view schematically illustrating a capacitive touch apparatus according to an exemplary embodiment of the present invention.

Referring to FIG. 1, a capacitive touch apparatus 100 according to an exemplary embodiment of the present invention includes a capacitive touch panel 110 and a capacitance measuring circuit 120 disposed on the capacitive touch panel 110.

The capacitive touch panel 110 includes a base substrate 111, a plurality of main sensors 112, a plurality of sub-sensors 113 arranged in one-to-plural correspondence in parallel with the main sensors 112, a plurality of first main connection wirings 114, a plurality of second main connection wirings 115, a plurality of first sub-connection wirings 116 and a plurality of second sub-connection wirings 117. The main sensors 112, the sub-sensors 113, the first and second main connection wirings 114 and 115, and the first and second sub-connection wirings 116 and 117 may be formed by a silver material, a metal material, a graphene material, etc. In the present exemplary embodiment, for convenience of description, it is shown that the number of the main sensor 112 is three and the number of sub-sensor 113 is six; however, it is not limited thereto.

The base substrate 111 includes a touch area TA and a peripheral area PA surrounding the touch area TA. In the present exemplary embodiment, the base substrate 111 has a rectangular shape defined by a long side and a short side.

The main sensors 112 are disposed on a touch area TA to sense a touch position of a first axis. Each of the main sensors 112 has a bar shape to be extended along a first direction (e.g., a Y-axis direction) and to be arranged along a second direction (e.g., a X-axis direction). Each of the main sensors 112 has a uniform width.

The sub-sensors 513 are arranged in one-to-plural correspondence in parallel with the main sensors 512 to sense a touch position of a second axis. Each of the sub-sensors 513 is disposed between the main sensors 512 adjacent to each other, and is extended along a Y-axis direction to be arranged along a X-axis direction. In order to maintain the same as a resistance value of the different sub-sensors, a slit portion may be formed through an outmost sub-sensor among sub-sensors 113 disposed between the main sensors 112 adjacent to each other. A width of the slit portion and a length of the slip portion may be designed by a designer of a capacitive touch panel. The sub-sensors 113 may be disposed in adjacent to one main sensor. Each width of the sub-sensors 113 may be gradually increased toward a center portion of the capacitive touch panel from an edge portion of the capacitive touch panel.

In the present exemplary embodiment, the first axis may be a X-axis when the second axis is a Y-axis, and the second axis may be a Y-axis when the first axis is a X-axis.

The first main connection wirings 114 are connected to each first end portions of the main sensors 112. The first main connection wirings 114 may include a same material as the main sensors 112. Moreover, the first main connection wirings 114 may be formed when the main sensors 112 are formed.

The second main connection wirings 115 are connected to each second end portions of the main sensors 112. The second main connection wirings 115 may include a same material as the main sensors 112. Moreover, the second main connection wirings 115 may be formed when the main sensors 112 are formed.

The first sub-connection wirings 116 are connected to some of the sub-sensors 113 arranged along a first direction, and are extended in an upper direction when viewed from a plan view of the capacitive touch panel 110. The first sub-connection wirings 116 may include a same material as the sub-sensors 113. Moreover, the first sub-connection wirings 116 may be formed when the sub-sensors 113 are formed.

The second sub-connection wirings 117 are connected to the remaining of the sub-sensors 113 arranged along a first direction, and are extended in a lower direction when viewed from a plan view of the capacitive touch panel 110. The second sub-connection wirings 117 may include a same material as the sub-sensors 113. Moreover, the second sub-connection wirings 117 may be formed when the sub-sensors 113 are formed.

In the present exemplary embodiment, when it is assumed that a line which is vertical to a length direction of the main sensor 112 and passing a center area of the main sensor 112 is an imaginary line, the first sub-connection wiring 116 is connected to first and second sides of a sub-sensors disposed on an upper area with respect to the imaginary line, and the second sub-connection wiring 117 is connected to first and second sides of a sub-sensors disposed on a lower area with respect to the imaginary line.

The capacitive touch panel 110 may further include a plurality of first sub-bypass wirings 118 and a plurality of second sub-bypass wirings 119. Each of the first sub-bypass wirings 118 and the second sub-bypass wirings 119 may be formed by a silver material, a metal material, a graphene material, etc.

The first sub-bypass wirings 118 are disposed on the peripheral area PA to be respectively connected to each of the first sub-connection wirings 116 in one-to-one correspondence. In the present exemplary embodiment, each of the first sub-bypass wirings 118 may play a role of delivering a sensing signal outputted from the capacitance measuring circuit 120 to each of the sub-sensors 113 via the first sub-connection wirings 116, and may play a role of receiving a sensing signal sensed at each of the sub-sensors 113 via the first sub-connection wirings 116 to delivery the sensing signal to the capacitance measuring circuit 120.

The second sub-bypass wirings 119 are disposed at the peripheral area PA to be connected to each of the second sub-connection wirings 117 in one-to-one correspondence. In the present exemplary embodiment, each of the second sub-bypass wirings 119 may play a role of delivering a sensing signal outputted from the capacitance measuring circuit 120 to each of the sub-sensors 113 via the second sub-connection wirings 117, and may play a role of receiving a sensing signal sensed at each of the sub-sensors 113 via the second sub-connection wirings 117 to delivery the sensing signal to the capacitance measuring circuit 120. For example, when the first sub-bypass wirings 118 play a role of delivering a sensing signal outputted from the capacitance measuring circuit 120 to the sub-sensors 113, the second sub-bypass wirings 119 play a role of delivering a sensing signal sensed at the sub-sensor 113 to the capacitance measuring circuit 120. Meanwhile, when the first sub-bypass wirings 118 play a role of delivering a sensing signal sensed at the sub-sensor 113 to the capacitance measuring circuit 120, the second sub-bypass wirings 119 play a role of delivering a sensing signal outputted from the capacitance measuring circuit 120 to each of the sub-sensors 113.

The capacitance measuring circuit 120 is connected to two end portions of each of the main sensors 112 and the sub-sensors 113 to measure a touch position by sensing a capacitance variation of the main sensors 112 and the sub-sensors 113. Particularly, the capacitance measuring circuit 120 is connected to the main sensors 112 through the first main connection wirings 114 and the second main connection wirings 115, and is connected to the sub-sensors 113 through the first sub-bypass wirings 118 and the second sub-bypass wirings 119 to measure a touch position by sensing capacitance variations of the main sensors 112 and the sub-sensors 113.

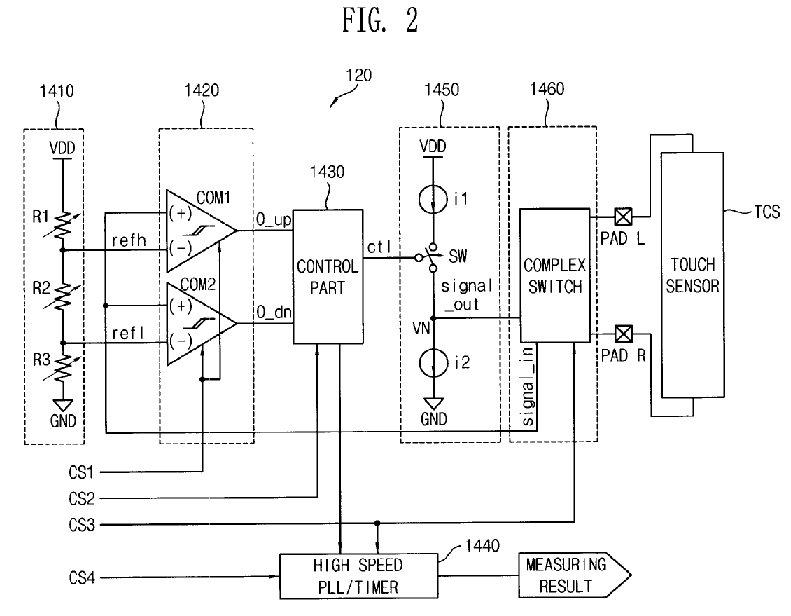

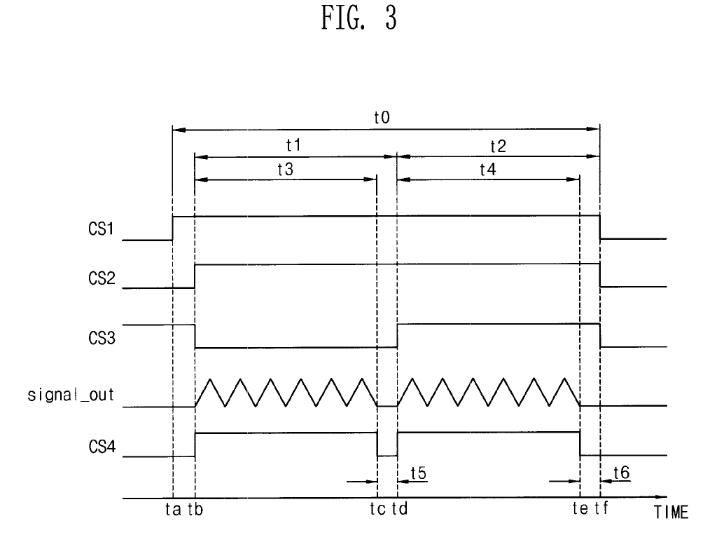

FIG. 2 is a block diagram schematically illustrating a capacitance measuring circuit 120 shown in FIG. 1. FIG. 3 is a block diagram schematically illustrating a capacitance measuring circuit 120 shown in FIG. 2.

Referring to FIG. 1, FIG. 2 and FIG. 3, a capacitance measuring circuit 120 includes a reference voltage generating part 1410, a voltage comparing part 1420, a control part 1430, a timer part 1440, a charging/discharging part 1450 and a complex switch 1460. The capacitance measuring circuit 120 is connected to plural touch sensors TCS to apply a constant current to the plural touch sensors TCS. The capacitance measuring circuit 120 measures capacitance of a corresponding touch sensor TCS by measuring entire discharging time required for discharging capacitance generated by the touch sensor TCS and human body at a reference voltage. In the present exemplary embodiment, the touch sensors TCS may be the main sensor 112 and the sub-sensor 113 shown in FIG. 1. Alternatively, the touch sensors TCS may be the main sensor 112 shown in FIG. 1.

Particularly, the charging/discharging circuit part 1450 continuously performs charging and discharging in a predetermined period N times. When capacitance is input from a touch sensor TCS connected to a complex switch 1466, time difference is generated in the predetermined period. The timer part 1440 measures an accumulated difference during N times to determine whether capacitance is input or not. As the charging/discharging times is increased, a time for the charging and discharging in creased when capacitance is measured through the touch sensor TCS.

The reference voltage generating part 1410 includes a first resistor R1, a second resistor R2 and a third resistor R3 which are serially connected to each other, and generates a first reference voltage ‘refh’ and a second reference voltage ‘refl’ to provide a voltage comparing part 20 with the first and second reference voltages refh and refl. In the present exemplary embodiment, each of the first to third resistors R1, R2 and R3 is a variable resistor.

A resistance of the variable resistor may be varied by a program. Thus, each of the first reference voltage ‘refh’ and the second reference voltage ‘refl’ is variable voltages.

When a power noise applied to a capacitance measuring circuit is great or a noise provided from an external side is great, the first reference voltage ‘refh’ and the second reference voltage ‘refl’ are varied by using a program, so that a reference voltage which is not affected by noises may be set.

In particular, as a size of a touch sense formed to sense capacitance is increased, a noise is more inflow due to an external environment so that a sensibility of capacitance is decreased. However, when the difference between a first reference voltage ‘vrefh’ and a second reference voltage ‘vrefl’ is controlled to have a small value, thereby more decreasing a noise characteristics. When the difference between the first reference voltage ‘refh’ and the second reference voltage ‘refl’ is set to have a small value, a signal-to-noise (SNR) for the measured result is enhanced; however, a sensing signal for capacitance is reduced. Thus, proper voltage values for the first reference voltage ‘refh’ and the second reference voltage ‘refl’ are selected.

The voltage comparing part 1420 compares with voltages generated in the reference voltage generating part 1410 and a sensing voltage provided from the touch sensor TCS in response to a first control signal provided from an external device (not shown). For example, the voltage comparing part 1420 includes a first voltage comparator COM1 and a second voltage comparator COM2. In the present exemplary embodiment, the first control signal enables or disables the first and second voltage comparators COM1 and COM2. That is, a first control signal of H level enables the first and second voltage comparators COM1 and COM2, and a first signal of L level enables the first and second voltage comparators COM1 and COM2.

In response to a first control signal of H level, the first voltage comparator COM1 compares with a first reference voltage ‘refh’ generated in the reference voltage generating part 10 and a sensing voltage input from the touch sensor TCS to output a first comparing signal O_up. The first comparing signal O_up is generated to have H level when a voltage of a signal compared in the first voltage comparator COM1 is greater than or equal to the first reference voltage ‘refh’, and is generated to have L level when the voltage of the signal compared in the first voltage comparator COM1 is smaller than the first reference voltage ‘refh’. When the first comparing signal O_up of H level is output, a charging/discharging signal ‘ctl’ output from the control part 1430 is controlled to be varied from H level to L level within a predetermined delay time of a normal operating time interval (e.g., an interval that a second control signal is H).

In response to a first control signal of H level, the second voltage comparator COM2 compares with a second reference voltage ‘refl’ generated in the reference voltage generating part 10 and a sensing voltage input from the touch sensor TCS to output a second comparing signal O_dn. The second comparing signal O_dn is generated to have H level when a voltage of a signal compared in the second voltage comparator COM2 is smaller than or equal to the second reference voltage ‘refl’, and is generated to have L level when the voltage of the signal compared in the second voltage comparator COM2 is greater than the second reference voltage ‘refl’. When the second comparing signal O_dn of H level is output, a charging/discharging signal ‘ctl’ output from the control part 1430 is controlled to be varied from L level to H level within a predetermined delay time of a normal operating time interval (e.g., an interval that a second control signal is H).

In the present exemplary embodiment, each of the first and second voltage comparators COM1 and COM2 may include a voltage comparator with hysteresis. The voltage comparator with hysteresis is so called as a comparator having a Schmitt trigger. By using the voltage comparator with hysteresis, it may prevent a comparator from being sensitively operated when a noise of a power voltage applied to a capacitance measuring circuit or a noise of a ground voltage is applied thereto. When a semiconductor really developed based on a present application is operated in an application circuit, a signal-to-noise ratio (SNR) may be enhanced from a noise of a power voltage.

The control part 1430 receives a first comparing signal O_up output from the first voltage comparator COM1, a second comparing signal O_dn output from the second voltage comparator COM2, and a second control signal provided from an external device, and controls an operation of the charging/discharging circuit part 1450 and an operation of the timer part 1440. For example, the control part 1430 provides the charging/discharging circuit part 1450 with a charging/discharging control signal ‘ctl’ in order to control an operation of the charging/discharging circuit part 1450. The charging/discharging control signal ‘ctl’ is transitioned from an L level to a H level when the second control signal is transitioned from an L level to a H level, and the charging/discharging control signal ‘ctl’ is transitioned from a H level to an L level when the first comparing signal is transitioned from an L level to a H level. Moreover, the charging/discharging control signal ‘ctl’ is transitioned from an L level to a H level when the second comparing signal is transitioned from an L level to a H level, and the charging/discharging control signal ‘ctl’ is transitioned from a H level to an L level when the first comparing signal is transitioned from an L level to a H level. That is, after the charging/discharging control signal ‘ctl’ is transitioned to an H level by the second control signal, the charging/discharging control signal ‘ctl’ is transitioned to an L level by the first control signal, and then the charging/discharging control signal ‘ctl’ is transitioned to an H level by the second control signal.

The charging/discharging circuit part 1450 is respectively connected to the control part 1430 and the complex switch 1460. In response to a charging/discharging control signal ‘ctl’, the charging/discharging circuit part 1450 charges a sensing signal ‘signal_in’ input through the complex switch 1460 from the first reference voltage ‘refh’ to the second reference voltage ‘refl’ or discharges the sensing signal ‘signal_in’ from the second reference voltage ‘refl’ to the first reference voltage ‘refh’. In the present exemplary embodiment, a switch SW, which is turned-on/off in response to the charging/discharging control signal ‘ctl’, is connected between a node VN corresponding to the sensing signal and a ground terminal.

That is, when the switch SW is turned-off, the charging/discharging circuit part 1450 provides the node with a charging current generated based on a power voltage of a power voltage terminal to charge a touch sensor TCS. When the switch SW is turned-on, the charging/discharging circuit part 1450 discharges a discharging current ‘i2’ corresponding to a touch sensor TCS through the ground terminal.

The complex switch 1460 switches input and output directions of a sensing signal in response to a third control signal provided from an external device. In the present exemplary embodiment, the third control signal may play a role of determining a signal delivering path of the complex switch 1460. That is, the complex switch 1460 may set a path of a capacitance sensing signal which is output from the charging/discharging circuit part 1450. The complex switch 1460 may set a path of the capacitance sensing signal, so that the capacitance sensing signal is passing from an upper portion (or left portion) of the touch sensor to a lower portion (or a right portion) of the touch sensor. Alternatively, the complex switch 1460 may set a path of the capacitance sensing signal, so that the capacitance sensing signal is passing from a lower portion (or a right portion) of the touch sensor to an upper portion (or a left portion) of the touch sensor.

The timer part 1440 measures charging time and discharging time of the charging/discharging circuit part 1450 in response to a fourth control signal from an external device. Moreover, the timer part 1440 measures entire charging time and entire discharging time, and outputs a measuring signal corresponding to the measured result. In the present exemplary embodiment, the fourth control signal controls an operation of the timer part 1440. For example, in an interval that the fourth control signal is a first edge of H level, the timer part 1440 is started to calculate the number of clocks corresponding to the predetermined period of a sensing signal ‘signal’. In an edge interval of L level, which is generated after an edge interval of the first H level, an operation of the timer part 1440 is stopped to maintain a value of the timer part 1440, and the timer part 1440 play a role of transmitting a measuring result.

In an interval that a second control signal is H level, the above operation is continuously repeated. A value of the timer part 1440 is recognized as a capacitance value of each pad by a third control signal.

An initial starting starts in an output signal of a charging/discharging circuit part 1450, that is, a ground level of a capacitance sensing signal. In this case, the output signal has a lower value lower than the first reference voltage ‘vrefh’ and a second reference voltage ‘vrefl’. The second reference voltage ‘vrefl’ is a voltage higher than 0 V of a ground voltage ‘GND’. For example, the second reference voltage ‘vrefl’ may be set as about 30 mV. The second reference voltage ‘vrefh’ may be set as about ½VDD to VDD-300 mV.

It will be described that a capacitance measuring circuit is operated in a normal status. When a voltage of the output signal is lower than vref, an output charging/discharging control signal ‘ctl’ of a control part 1430 is 0V so that a comparator 1420 and a control part 1430 operate to have a straight shape of a rising slop in a triangle shape from a second reference voltage ‘vrefh’ to a first reference voltage ‘vrefh’. Meanwhile, when a voltage of the output signal is reached at the first reference voltage ‘vrefh’, the switch SW is connected to an output terminal of the control part 1430 so that the comparator 1420 and the control part 1430 operate to have a straight shape of a falling slop in a triangle shape.

The sensing signal ‘signal’ of the charging/discharging circuit part 1450 play a role of operation of charging and discharging electric charges into a touch sensor TCS connected to a pad based on a charging current ‘i1’ and a discharging current ‘i2’, waveform according to increasing or decreasing may be a straight line shape.

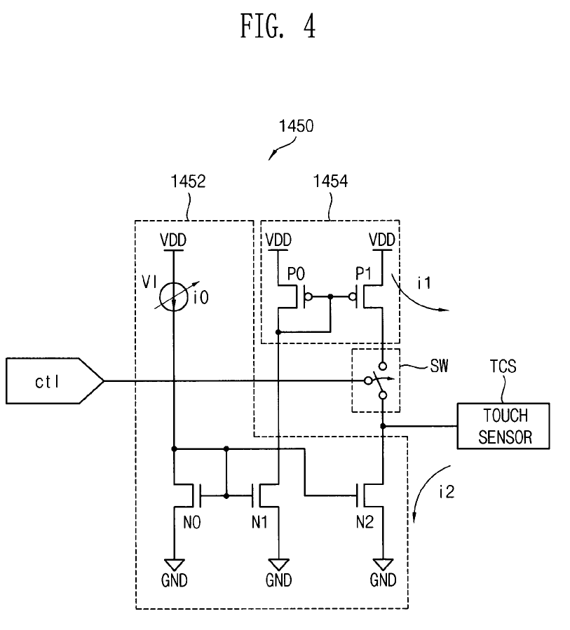

FIG. 4 is a circuit diagram illustrating one example of a charging/discharging circuit part 1450 shown in FIG. 2.

Referring to FIG. 4, a charging/discharging circuit part 1450 includes a charging part 1452 outputting a charging current for charging a touch sensor TCS, a discharging part 1454 receiving a discharging current for discharging the touch sensor TCS and a charging/discharging switch SW switching a connection between the charging part 1452 and the touch sensor TCS or a connection between the touch sensor TCS and the discharging part 1454.

The charging part 1452 includes a first PMOS transistor P0 and a second PMOS transistor P1. A source of the first PMOS transistor P0 and a source of the second PMOS transistor P1 are connected to a power voltage terminal providing a power voltage VDD, and gate and drain of the first PMOS transistor P0 are commonly connected to each other. Moreover, gates of the first and second PMOS transistors P0 and P1 are commonly connected to each other, so that a current mirror is configured. That is, the first PMOS transistor P0 and the second PMOS transistor P1 define a first current mirror. A drain of the second PMOS transistor P1 is connected to a touch sensor TCS and the charging/discharging switch SW.

The discharging part 1454 includes a variable constant current source VI, a first NMOS transistor MO, a second NMOS transistor N1 and a third NMOS transistor N2. The first NMOS transistor N0, the second NMOS transistor N1 and the third NMOS transistor N2 may define a second current mirror.

The variable constant current source VI determines a current amount of a second current mirror. The variable constant current source VI may include a variable resistor determining a current amount of a bias of the first NMOS transistor N0. A current amount between a drain and source ‘GND’ of the first NMOS NO is determined by a resistance value of the variable resistor.

In the first NMOS transistor N0, a source is connected to a variable constant current source VI, a drain is connected to a ground terminal, and a gate is connected to a gate of the second NMOS transistor N1.

In the second NMOS transistor N1, a source is connected to a drain of the first NMOS transistor N0, a gate is commonly connected to gate and source of the first NMOS transistor N0, and a drain is connected to a ground terminal GND.

In the third NMOS transistor N2, a source is connected to the charging/discharging switch SW, a gate is connected to a gate of the second NMOS transistor N1, and a drain is connected to a ground terminal GND. Source and gate of the first NMOS transistor N0 is commonly connected to each other and gate of the second NMOS transistor N1 is connected to the third NMOS transistor N2, so that it is configured to define a current-mirror. That is, the first NMOS transistor N0, the second NMOS transistor N2 and the third NMOS transistor N2 may define a second current mirror.

The charging/discharging switch SW includes a first terminal connected to the charging part 1452, a second terminal connected to the discharging part 1454 and the touch sensor TCS and a control terminal receiving a charging/discharging control signal ‘ctl’ from an external device. The charging/discharging switch SW is tuned-on or turned-off by the charging/discharging control signal ctl′.

When the charging/discharging switch SW is turned-on, an electric path is formed between a charging part 1452 and a touch sensor TCS, so that a charging current output from the charging part 1452 is provided to the touch sensor TCS to charge the touch sensor TCS.

When the charging/discharging switch SW is turned-off, an electric path is blocked between the charging part 1452 and the touch sensor TCS and an electric path between the touch sensor TCS and a discharging part 1454 is formed, so that a current charged in the touch sensor TCS is provided to the discharging part 1454 to discharge the touch sensor TCS.

As described above, the first PMOS transistor P0 and the second NMOS transistor N1 are mirroring a current of the second PMOS transistor P1.

The second PMOS transistor P1 and the third NMOS transistor N2 are for charging or discharging capacitance to a touch sensor TCS may perform a function of providing current substantially equal to a current of the first NMOS transistor N0 determined by the variable constant current source VI.

In the present exemplary embodiment, it is designed that a charging current is not equal to a discharging current ‘i2’ and the discharging current ‘i2’ is greater than the charging current. Moreover, in order to realize that a rising time of a triangle wave of a sensing signal is equal to a falling time of the triangle wave, it is designed that the discharging current ‘i2’ is twice of the charging current ‘i1’.

N0=N1 [Equation 1]

N2=N0*2 [Equation 2]

Alternatively, a first PMOS transistor P0 and a second PMOS transistor P1 may be designed to have channel widths of an equal size. In this case, it is assumed that channel lengths of all FET transistors are equal to each other.

Thus, during an interval when a charging/discharging switch SW operated in response to a charging/discharging control signal ‘ctl’ is an “OFF” status, a voltage of a sensing signal is increased to have a slop of a straight type since it is charged by a charging current ‘i1’.

Meanwhile, during an interval when the charging/discharging switch SW is an “ON” status, it is discharged by an electric current corresponding to i2−i1=i1 (here, i2−i1*2), that is, a discharging current ‘i2’; however, a charging operation is also performed by a charging current corresponding to a half of the charging current ‘i2’. Thus, a final discharging current applied by a touch sensor signal ‘signal’ is discharged into a current amount of the charging current so that a voltage of a signal is linearly decreased.

When a current equation of i2=i1*2 and an operation of a charging/discharging switch SW are used, an interval that a current is 0 is not generated any moment in a signal line sensing capacitance so that it is strong to an external noise to enhance a sensibility of capacitance.

In this exemplary embodiment, when each channel lengths of the first and second PMOS transistors P0 and P1 and the first to third NMOS transistors NO, N1 and N2, a channel width of the first PMOS transistor P0 and a channel width of the second PMOS transistor P1 are equal to each other, a channel width of the first NMOS transistor N0 and a channel width of the second NMOS transistor N1 are equal to each other, and a channel width of the third NMOS transistor N2 is twice of a channel width of the first NMOS transistor N0. Alternatively, it will be apparent to persons of ordinary skill in the art that channel lengths and channel widths of the FETs may be varied in order to perform a current mirroring operation.

For example, when each channel lengths of first and second PMOS transistors P0 and P1 and the first to third NMOS transistors NO, N1 and N2 is substantially equal to each other, a ratio of a channel width of the first PMOS transistor P0 to a channel width of the second PMOS transistor P1 may be 1:N (‘N’ is a natural number), a ratio of a channel width of the first NMOS transistor N0 to a channel width of the second NMOS transistor N1 may be 1:N, and a ratio of a channel width of the first NMOS transistor N0 to a channel width of the third NMOS transistor N2 may be 1:N*M (‘M’ is 2*N).

For example, when N is 1 and M is 2, a channel width relationship between FETs is expressed as the following Equation 3.

P0:P1=1:1,

N0:N1:N3=1:1:2 [Equation 3]

Meanwhile, when N is 4 and M is 2, a channel width relationship between FET transistors is expressed as the following Equation 4.

P0:P1=1:4,

N0:N1:N2=1:4:8 [Equation 4]

FIG. 5 is a circuit diagram illustrating another example of a charging/discharging circuit part 1450 shown in FIG. 2.

Referring to FIG. 5, a charging/discharging part 1550 includes a charging/discharging switch 1610, a first current mirror 1620, a second current mirror 1630, a discharging control part 1640, a discharging part 1650, a third current mirror 1660, a charging control part 1670 and a charging part 1680.

The charging/discharging switch 1610 is on or off in accordance with a charging/discharging control signal provided from an external device (not shown). The charging/discharging switch 1610 includes NMOS N11 turned-on or turned-off in accordance with a charging/discharging control signal received through a gate. NMOS N11 is turned-on when a charging/discharging control signal of H level is received, and is turned-off when a charging/discharging control signal of L level is received.

The first current mirror 1620 provides a first bias current corresponding to a power source voltage. The first current mirror 1620 includes PMOS P21, PMOS P22, PMOS P23 and PMOS P24. In the present exemplary embodiment, PMOS P21 and PMOS P22 are serially connected to each other, and PMOS P23 and PMOS P24 are serially connected to each other. A gate of PMOS P21 and a gate of PMOS P23 are commonly connected to each other, and a gate of PMOS P22 and a gate of PMOS P24 are commonly connected to each other. A source of PMOS P21 and a source of PMOS P23 are commonly connected to a power voltage terminal to receive a power voltage VDD, and a drain of PMOS P22 is connected to a ground terminal.

The second current mirror 1630 is mirrored by the first bias current to output a second bias current. The second current mirror 1630 includes a PMOS transistor P31, a PMOS transistor P32, a PMOS transistor P33 and a PMOS transistor P34. In the present exemplary embodiment, the PMOS transistor P31 and the PMOS transistor P32 are serially connected to each other, and the PMOS transistor P33 and the PMOS P34 are serially connected to each other. A source of the PMOS transistor P31 and a source of the PMOS transistor P33 are respectively connected to as power voltage terminal to receive a power voltage VDD. A gate of the PMOS transistor P31 and a gate of the PMOS transistor P33 are respectively connected to a gate and a source of the PMOS transistor P21 of the first current mirror 1620. A gate of the PMOS transistor P32 and a gate of the PMOS transistor P34 are respectively connected to a gate and a source of the PMOS transistor P22 of the first current mirror 1620.

The discharging control part 1640 outputs a discharging control signal based on the second bias current. The discharging control part 1640 includes an NMOS transistor N41, an NMOS transistor N42 and an NMOS transistor N43. In the present exemplary embodiment, a source and a gate of the NMOS transistor N41 are commonly connected to be connected to a drain of the PMOS transistor P32 of a second current mirror 1630, and a drain of the NMOS transistor N41 is connected to a ground terminal. A source of the NMOS transistor N42 is connected to a drain of a PMOS transistor P34 of the second mirror 1630, and a drain of the NMOS transistor N42 is connected to a source and a gate of the NMOS transistor N41. A source of the NMOS transistor N43 is connected to a drain of the NMOS transistor N42, a gate of the NMOS transistor N43 is connected to a drain of a PMOS transistor P34, and a drain of the NMOS transistor N43 is connected to a ground terminal.

The discharging part 1650 is electrically connected to a touch sensor to discharge electric charges of the touch sensor in response to the discharging control signal. The discharging part 1650 includes an NMOS transistor N51 and an NMOS transistor N52. In the present exemplary embodiment, the NMOS transistor N51 and the NMOS transistor N52 are serially connected to each other. A gate of the NMOS transistor N51 is connected to a gate of an NMOS transistor N42 of the discharging control part 1640, and a gate of the NMOS transistor N52 is connected to a gate of an NMOS transistor N43 of the discharging control part 1640. A source of the NMOS transistor NM is connected to the touch sensor. A drain of the NMOS transistor N52 is connected to a ground terminal.

When the charging switch 1610 is turned-off, the third current mirror 1660 mirrors a current corresponding to the first bias current. The third current mirror 1660 includes an NMOS transistor N61, an NMOS transistor N62, an NMOS transistor N63, an NMOS transistor N64, an NMOS transistor N65 and an NMOS transistor N66. In the present exemplary embodiment, the NMOS transistor N61 and the NMOS transistor N63 are serially connected to each other, the NMOS transistor N62 and the NMOS transistor N64 are serially connected to each other, and the NMOS transistor N65 and the NMOS transistor N66 are serially connected to each other. A source and a drain of the NMOS transistor N61 are commonly connected to each other to be connected to a drain of the PMOS transistor P24 of the first current mirror 1620, a gate of the NMOS transistor N62 and a gate of the NMOS transistor N65. A source of the NMOS transistor N62 is connected to the charging control part 1670. A source and a gate of the NMOS transistor N63 are commonly connected to each other to be connected to a drain of the NMOS transistor N61, a gate of the NMOS transistor N64 and a gate of the NMOS transistor N66. A drain of the NMOS transistor N63 is connected to a ground terminal, a drain of the NMOS transistor N64 is connected to a ground terminal and a drain of the NMOS transistor N66 is connected to a ground terminal.

The charging control part 1670 outputs a charging control signal by mirroring of the third current mirror 1660. The charging control part 1670 includes a PMOS transistor P71, a PMOS transistor P72 and a PMOS transistor P73. In the present exemplary embodiment, the PMOS transistor P71 and the PMOS P72 are serially connected to each other. A source of the PMOS transistor P71 is connected to a power voltage terminal to receive a power voltage, and a gate of the PMOS transistor P71 is commonly connected to a drain of the PMOS transistor P72 to be connected to the charging part 1680. Moreover, a drain of the PMOS transistor P72 is connected to a source of a NMOS transistor N62 of a third current mirror 1660. A source of the PMOS transistor P73 is connected to a power voltage terminal to receive a power voltage, and a gate of the PMOS transistor P73 is commonly connected to a gate of the PMOS transistor P72 to be connected to the charging part 1680. A drain of the PMOS transistor P73 is connected to a source of an NMOS transistor N65 of the third current mirror 1660.

The charging part 1680 is electrically connected to the touch sensor to charge electric charges to the touch sensor in response to the charging control signal. The charging part 1680 includes a PMOS transistor P81, a PMOS transistor P82, a PMOS transistor P83 and a PMOS transistor P84. In the present exemplary embodiment, the PMOS transistor P81 and the PMOS transistor P82 are serially connected to each other, and the PMOS transistor P83 and the PMOS transistor P84 are serially connected to each other. A source of the PMOS transistor P81 is commonly connected to a source of the PMOS transistor P83 to be connected to a power voltage terminal to receive a power voltage VDD. A gate of the PMOS transistor P81 and a gate of the PMOS transistor P83 are commonly connected to be connected to a gate of a PMOS transistor P71 and a drain of a PMOS transistor P72 of the charging control part 1670. A gate of the PMOS transistor P82 and a source of the PMOS transistor P84 are commonly connected to be connected to a gate of a PMOS transistor P72 of the charging control part 1670. A drain of the PMOS transistor P82 and a drain of the PMOS transistor P84 are commonly connected to be connected to the touch sensor and a source of an NMOS transistor NM of the discharging part 1650.

Hereinafter, an operation of the charging/discharging circuit part 1550 shown in FIG. 5 will be briefly described.

When a charging/discharging control signal ‘ctl’ of L level is provided to the charging/discharging switch 1610, the charging/discharging switch 1610 configured by NMOS transistors is turned-off. The second current mirror 1630 is activated by a first mirroring current output from the first current mirror 1620, so that the second current mirror 1630 provides the discharging control part 1640 with a second mirror current. The second discharging control part 1640 activates the discharging part 1650 based on the second mirroring current. The discharging part 1650 activated by discharging control part 1640 discharges electrical charges charged at a touch sensor through a ground terminal. In this case, a first current mirror output from the first current mirror 1620 is provided to the third current mirror to play a role of a bias current.

When a charging/discharging control signal ‘ctl’ of H level is provided to the charging/discharging switch 1610, the charging/discharging switch 1610 configured by NMOS transistors is turned-on. When the charging/discharging switch 1610 is turned-on, a first mirror current output from the first current mirror 1620 is also provided to the charging/discharging switch 1610 so that the third current mirror 1660 mirrors a low current having relatively level. Since the third current mirror 1660 mirrors a current having a relatively low level, the charging control part 1670 configured by PMOS transistors is activated to activate the charging part 1680. When the charging part 1680 is activated, the charging part 1680 provides a touch sensor with electrical charges to charge the touch sensor. In this case, a voltage charged by the charging part 1680 is greater than a voltage of the touch sensor discharged by the discharging part 1650. Thus, electrical charges charged at the touch sensor are discharged when the charging part 1680 is inactivated; however, a current corresponding to a power voltage VDD is provided to the touch sensor to charge the touch sensor when the charging part 1680 is activated.

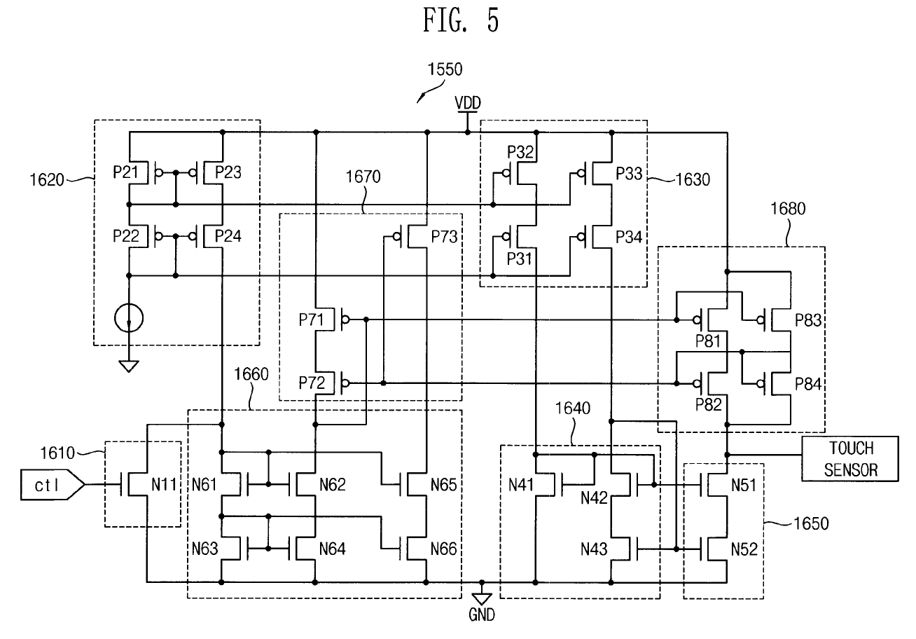

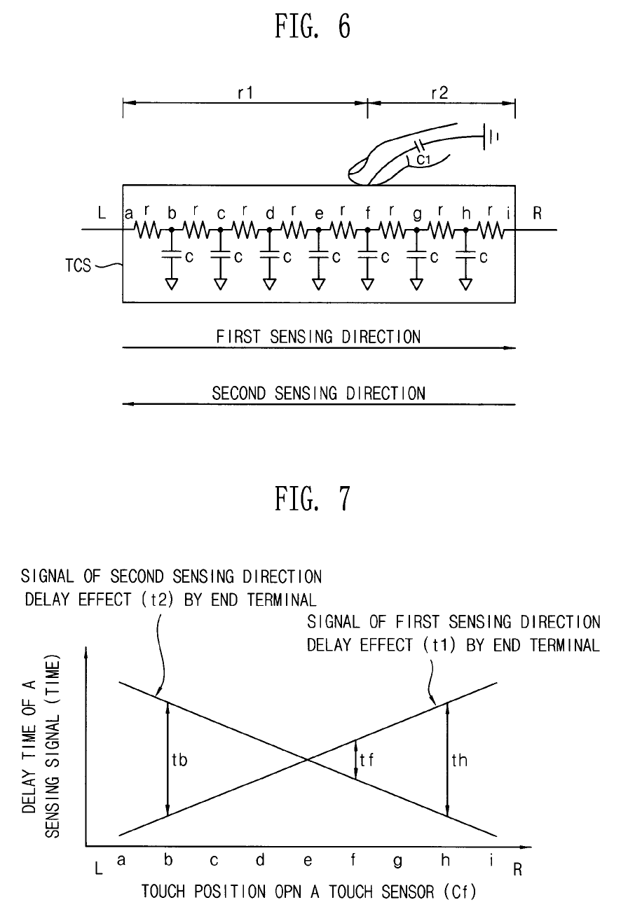

FIG. 6 is a schematic diagram schematically explaining a capacitance sensing through a capacitive touch panel shown in FIG. 1.

Referring to FIG. 1 and FIG. 6, a plurality of touch sensors TCS is disposed on a capacitive touch panel 100. The touch sensor TCS is formed by patterning a conductive material such as indium thin oxide (ITO) or carbon nano tube (CNT) having a uniform resistance per unique square. In the present exemplary embodiment, the touch sensor TCS is formed in a single layer.

The touch sensor TCS has a uniform resistance component ‘r’ along a left and right direction, and has a minute parasitic capacitance ‘c’ in air or a virtual ground.

It is assumed that a touch for a human body is generated at ‘f’ position. In case of applying a sensing signal along a left and right direction (that is, a first sensing direction), a signal delay effect of 5*(r//c)+Cf is generated. In case of applying a sensing signal along a right and left direction (that is, a second sensing direction), a signal delay effect of 3*(r//c)+Cf is generated.

A physical position on a touch sensor where a touch is generated may be calculated by using the difference of delay time.

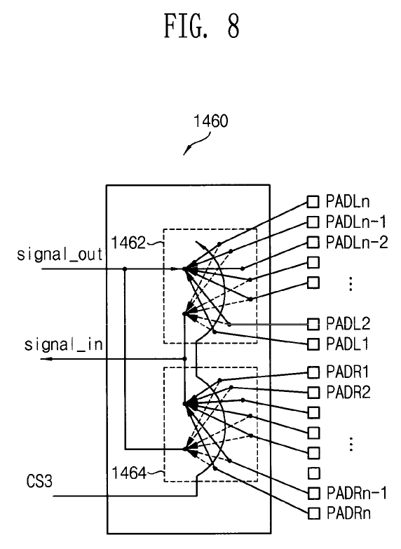

In order to generalize the above, when touch ‘Cf’ by a finger of the human body are generated in each positions of a, b, c, d, e, f, g, h and i, a delay phenomenon for sensing signals of a first sensing direction and a second sensing direction will be expressed as the following FIG. 8.

FIG. 7 is a graph schematically explaining a delaying of a sensing signal along a first sensing direction and a second sensing direction shown in FIG. 6.

Referring to FIG. 7, as a touch position is progressing from ‘a’ to T, a delay time of a sensing signal is increased in a first sensing direction. As a touch position is progressing from T to ‘a’, a delay time of a sensing signal is decreased in a second sensing direction.

The difference between a delay time measured in the first sensing direction and a delay time measured in the second sensing direction corresponds to a physical position on each touch sensors.

Time delay effects according to the first and second sensing directions are not shown in a straight line having a uniform slop such as shown in FIG. 7. However, its shapes are similar in form to a straight line shape, so that it expressed in a straight line.

FIG. 8 is a schematic diagram explaining a complex switch shown in FIG. 2.

Referring to FIGS. 2 and 8, a complex switch 1460 includes a first switch 1462 and a second switch 1464.

The first switch 1462 is connected to the charging/discharging circuit part 1450, each first terminals of the touch sensors, and the voltage comparing part 1420 to switch a sensing signal passing the touch sensor to a first path in response to a third control signal provided from an external device.

The second switch 1464 is connected to the charging/discharging circuit part 1450, each second terminals of the touch sensors, and the voltage comparing part 1420 to switch a sensing signal passing the touch sensor to a second path in response to a third control signal provided from an external device.

When the third control signal has a first level, the first switch 1462 connects to the charging circuit part 1450 and the first terminal of the touch sensor and the second switch 1464 connects to the second terminal of the touch sensor and the voltage comparing part 1420.

When the third control signal has a second level, the second switch 1464 connects to the charging circuit part 1450 and the second terminal of the touch sensor and the first switch 1462 connects to the first terminal of the touch sensor and the voltage comparing part 1420.

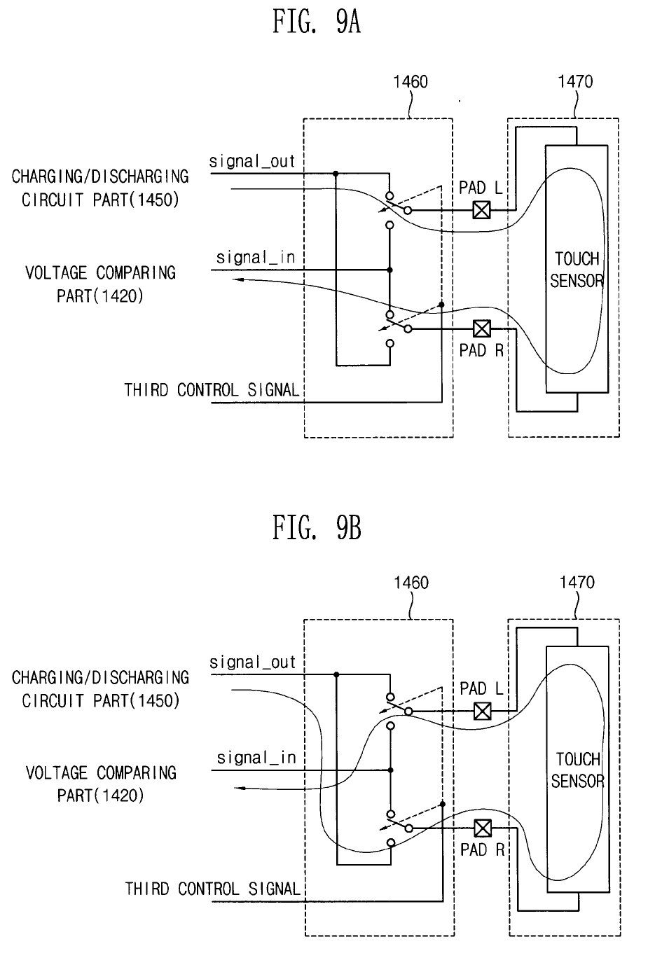

FIGS. 9A and 9B are schematic diagrams explaining a path of a capacitance sensing signal. Particularly, FIG. 9A shows a path of a capacitance sensing signal passing from a left side of a touch sensor to a right side of the touch sensor, and FIG. 9B shows a path of a capacitance sensing signal passing from the right side of the touch sensor to a left side of the touch sensor.

Referring to FIG. 9A, a sensing signal is transmitted from a left side of a touch sensor to a right side of the touch sensor and the transmitted signal is output through the right side of the touch sensor, so that a variation amount of capacitance is sensed.

When a third control signal is 0, a sensing signal ‘signal_out’ output from a charging/discharging circuit part 450 is applied to an upper side of a touch sensor through SW0 and PAD L, and a signal passing the touch sensor is applied to a voltage comparing part 420 through PAD R and SW1 via a lower side of the touch sensor. In this case, a first sensing path may be defined.

Referring to FIG. 9B, a sensing signal is transmitted from a right side of a touch sensor to a left side of the touch sensor and the transmitted signal is output through the left side of the touch sensor, so that a variation amount of capacitance is sensed.

When a third control signal is 1, a sensing signal ‘signal_out’ output from a charging/discharging circuit part 450 is applied to a lower side of the touch sensor through SW1 and PAD R, and a signal passing the touch sensor is applied to a voltage comparing part 420 through PAD L and SW0 via an upper side of the touch sensor. In this case, a second sensing path may be defined.

In a conventional art, capacitance measuring circuits are respectively connected to two end portions of a touch sensor. That is, since two capacitance measuring circuits are used therein, a silicon size within a semiconductor IC is dissipated. Moreover, a measuring value is not convergent to a uniform value due to a deviation between two circuits.

However, according to the present invention, since a flowing of a first sensing path and a flowing of a second sensing path are opposite to each other, a sensing path is controlled through a complex switch 1460 by using one capacitance measuring circuit to obtain the measuring value so that an error ratio due to a deviation of internal circuits of a semiconductor may be decreased.

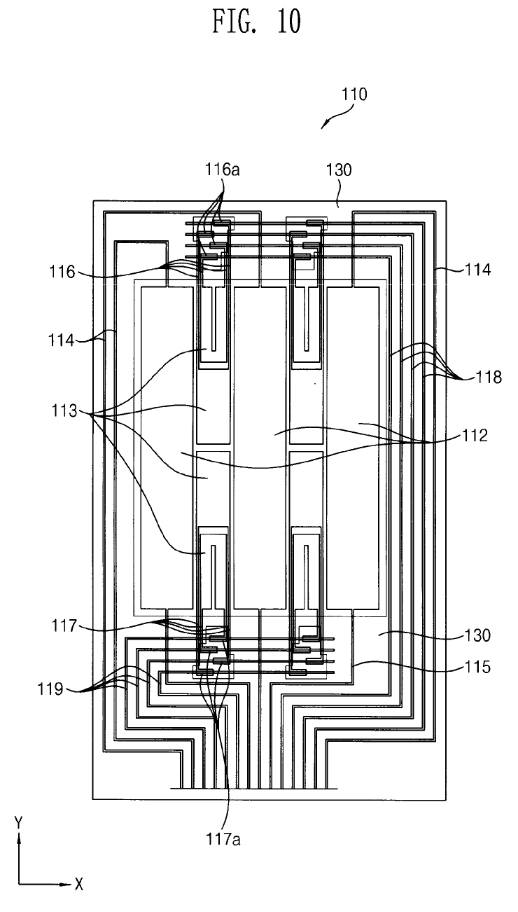

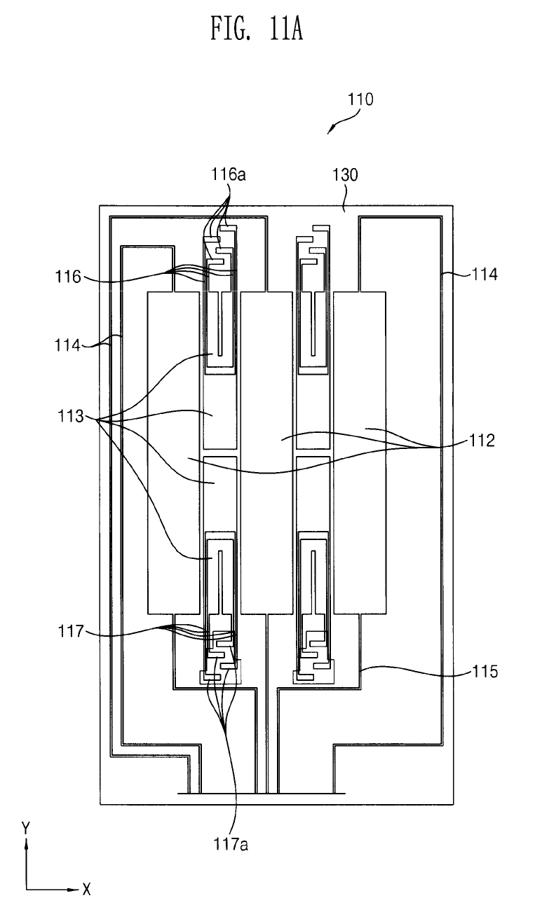

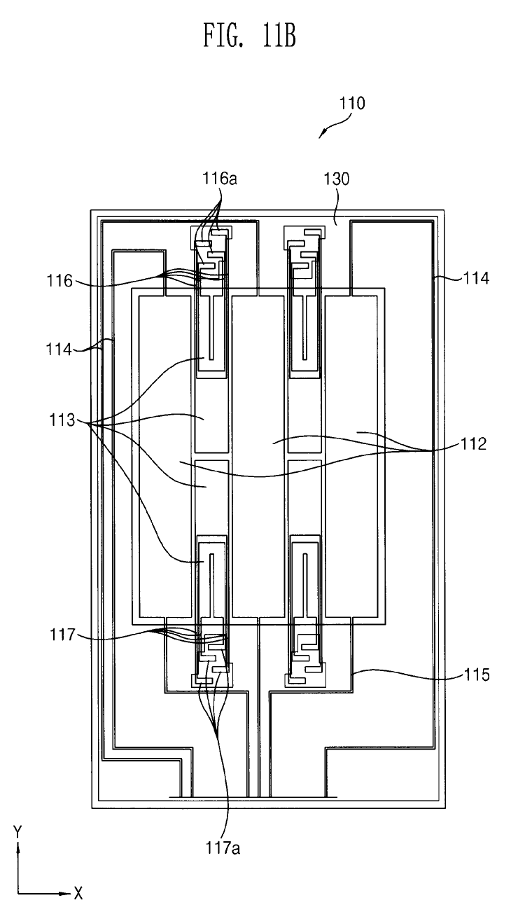

FIG. 10 is a plan view schematically illustrating an example of a capacitive touch panel shown in FIG. 1. Particularly, it is shown that holes are formed trough an insulation layer.

Referring to FIG. 10, a capacitive touch panel 110 includes a touch area TA defined on a base substrate 111 and a peripheral area PA surrounding the touch area TA. The base substrate 111 may be a ridge type transparent material such as glass or an enhanced glass, or a flexible type transparent material such as a film.

The capacitive touch panel 110 includes a main sensor 112, a sub-sensor 113, an insulation layer 130, first and second main connection wirings 114 and 115, first and second sub-connection wirings 116 and 117, and first and second sub-bypass wirings 118 and 119.

In the present exemplary embodiment, the main sensor 112, the sub-sensor 113, the first and second main connection wirings 114 and 115, the first and second sub-connection wirings 116 and 117, and the first and second sub-bypass wirings 118 and 119 may include an optically transparent and electrically conductive material such as indium tin oxide (ITO) or indium zinc oxide (IZO).

Meanwhile, the main sensor 112, the sub-sensor 113, the first and second main connection wirings 114 and 115, the first and second sub-connection wirings 116 and 117 may include an optically transparent and electrically conductive material such as indium tin oxide (ITO) or indium zinc oxide (IZO), and the first and second sub-bypass wirings 118 and 119 may include a material having superior conductivity such as cupper (Cu) or silver (Ag). In this case, the main sensor 112, the sub-sensor 113, the first and second main connection wirings 114 and 115, the first and second sub-connection wirings 116 and 117 may include the same material to be formed in the same layer through the same process.

The main sensor 112 is disposed on the touch area TA to be extended along a Y-axis direction. In the present exemplary embodiment, for convenience of description, it is shown that the number of the main sensor 112 is three; however, it is not limited thereto.

The sub-sensor 113 is disposed on the touch area TA to be extended along a Y-axis direction. In the present exemplary embodiment, for convenience of description, it is shown that the number of the main sensor 113 adjacent to one main sensor 112 is four; however, it is not limited thereto.

The first and second main connection wirings 114 and 115 are extended from the main sensor 112 to be disposed on a peripheral area PA and to be connected to a capacitance measuring circuit 120. The first and second main connection wirings 114 and 115 may be patterned when the main sensor 112 is formed.

First end portions of each of the first and second sub-connection wirings 116 and 117 are connected to two end portions of the sub-sensor 113 to be extended at a peripheral area PA along a Y-axis direction (or a −Y-axis direction). The each of the first and second sub-connection wirings 116 and 117 may be patterned when the sub-sensor 113 is formed.

A second end portion of the first sub-connection wiring 116 is bent to define a first sub-pad member 116a. The first sub-pad member 116a is bent toward an X-axis direction on the peripheral area PA. A width of the first sub-pad member 116a may be substantially equal to that of the first sub-connection wiring 116. Alternatively, a width of the first sub-pad member 116a may be greater than that of the first sub-connection wiring 116. In the present exemplary embodiment, it is shown that the first sub-pad members 116a bent from two first sub-connection wirings 116 extended from one sub-sensor 113 are formed to be faced each other; however, the first sub-pad members 116a may be bent toward the different direction to be formed. Moreover, the first sub-pad members 116a bent from two first sub-connection wirings 116 extended from one sub-sensor 113 may be bent along the same direction.

A second end portion of the second sub-connection wiring 117 is bent to define a second sub-pad member 117a. The second sub-pad member 117a is bent toward an X-axis direction on the peripheral area PA. A width of the second sub-pad member 117a may be substantially equal to that of the second sub-connection wiring 117. Alternatively, a width of the second sub-pad member 117a may be greater than that of the second sub-connection wiring 117. In the present exemplary embodiment, it is shown that the second sub-pad members 117a bent from two second sub-connection wirings 117 extended from one sub-sensor 113 are formed to be faced each other; however, the second sub-pad members 117a may be bent toward the different direction to be formed. Moreover, the second sub-pad members 117a bent from two second sub-connection wirings 117 extended from one sub-sensor 113 may be bent along the same direction.

The insulation layer 130 is formed on the peripheral area PA to expose the first and second sub-pad members 116a and 117a. In the present exemplary embodiment, the insulation layer 130 is formed only in the remaining area except for an area corresponding to the first and second sub-pad members 116a and 117a and a touch area TA, so that an additional process for forming a via hole exposing the first and second sub-pad members 116a and 117b may be omitted.

The first and second sub-bypass wirings 118 and 119 are formed on the peripheral area PA. The first and second sub-bypass wirings 118 and 119 are formed in an X-axis direction to be bent in a Y-axis direction, and then are bent in a X-axis direction to be connected to a capacitance measuring circuit 120. Each of the first and second sub-bypass wirings 118 and 119 makes contact with the first sub-pad member 116a and the second sub-pad member 117a exposed by the insulation layer 130.

As described above, according to the present exemplary embodiment, sub-pad members are vertically bent in based on a length direction of the sub-sensor, so that it may secure a contact area between a sub-connection wiring and a sub-pad member even though a width of the sub-pad member is narrow. Accordingly, it may reduce the probability of contact failure between the sub-connection wirings and the sub-pad member.

Moreover, the sub-pad members are vertically bent in based on a length direction of the sub-sensor, so that it may reduce a width of an area on which the sub-pad members are disposed. The area on which the sub-pad members are disposed may correspond to a bezel of a capacitive touch panel. Accordingly, it may reduce a bezel width of a capacitive touch panel.

Moreover, the sub-pad members are disposed in parallel with each other, so that it may reduce a wiring complexity of the sub-bypass wirings making contacting to each of the sub-pad members. Accordingly, it may enhance a signal-to-noise ratio (SNR) of a signal delivered through the sub-bypass wiring and may enhance a work yield.

Moreover, an insulation layer is formed only in the remaining area except for an area corresponding to each of the sub-bypass wirings and each of the sub-pad members during a drawing process, so that an additional process for forming a via hole on the insulation layer may be omitted so that it may reduce a manufacturing cost of a capacitive touch panel.

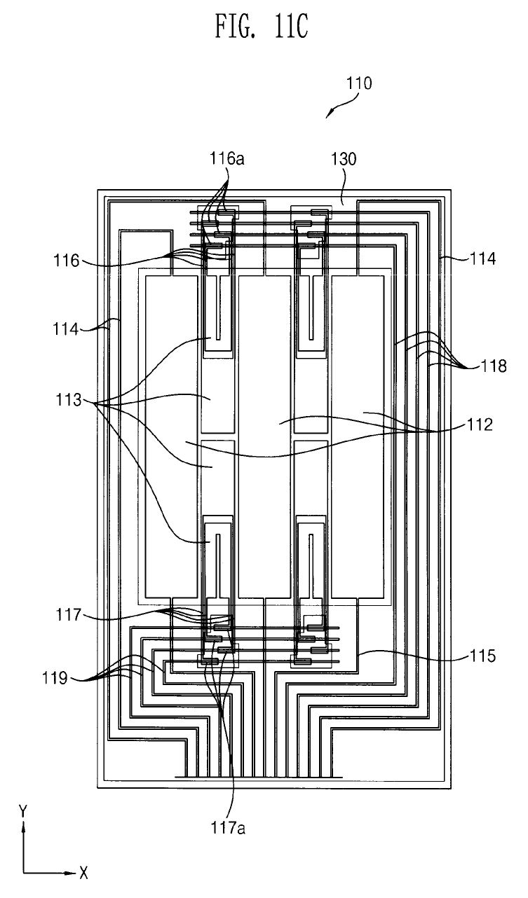

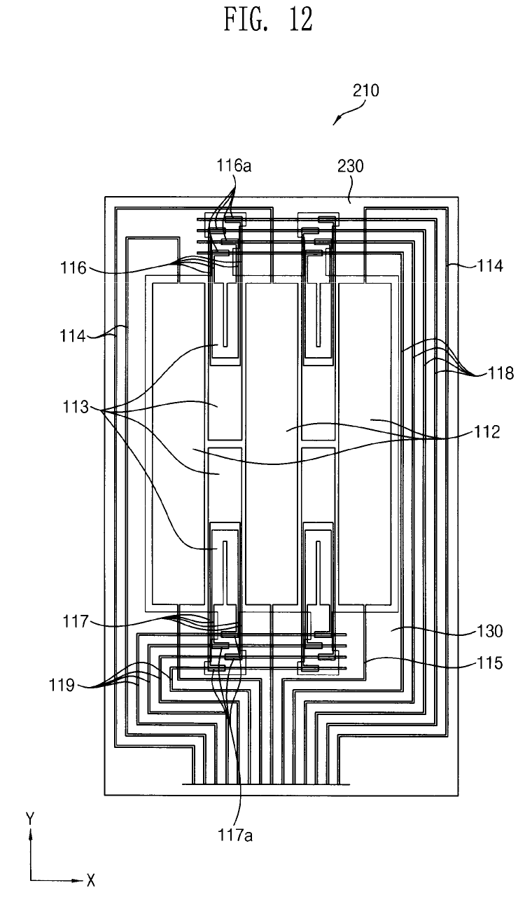

FIGS. 11A to 11C are plan views illustrating a manufacturing method of the capacitive touch panel shown in FIG. 10.

Referring to FIG. 11A, a main sensor 112 extended along a Y-axis direction, first and second main connection wirings 114 and 115 extended from two end portions of the main sensor 112, a sub-sensor 113 adjacent to the main sensor 112, first and second sub-connection wirings 116 and 117 extended from the sub-sensor 113, and first and second sub-pad members 116a and 117a respectively extended from the first and second sub-connection wirings 116 and 117 are formed on a base substrate 111.

The main sensor 112 and the sub-sensor 113 are formed on a touch area TA, and the first and second main connection wirings 114 and 115, the first and second sub-connection wirings 116 and 117 and the first and second sub-pad members 116a and 117a are formed on a peripheral area PA.

In FIG. 11A, first sub-pad members 116a, which are bent from two first sub-connection wirings 116 extended from one sub-sensor 113, are formed to face with each other; however the first sub-pad members 116a may be bent in the different direction. Moreover, first sub-pad members 116a, which are bent from two first sub-connection wirings 116 extended from one sub-sensor 113, may be bent along the same direction.

The main sensor 112, the first and second main connection wirings 114 and 115, the sub-sensor 113, the first and second sub-connection wirings 116 and 117, and the first and second sub-pad members 116a and 117a may be formed by various forming processes. For example, it may be formed through a photolithograph process after depositing an optically transparent and electrically conductive material such as indium tin oxide (ITO) or indium zinc oxide (IZO). The optically transparent and electrically conductive material such as ITO or IZO may be coated on a base substrate 111 in a thin film by ink jet printing, wet-coating, dry-coating or the like.

Referring to FIG. 11B, an insulation layer 130 exposing the first and second sub-pad members 116 and 117 is formed on the peripheral area PA. The insulation layer 130 may be silicon oxide (SiOx) or silicon nitride (SiNx), it is also possible other suitable insulation material. The material of dielectric coefficient of 2 to 4 may be used as the insulation layer 130. Further, the light-transmissive ink may be used as the insulation layer 130, and the insulating material of the light blocking cucurbit be used as the insulation layer 130. Forming method of the insulation layer 130 may be realized by various processes.

Referring to FIG. 11C, first and second sub-bypass wirings 118 and 119 making contact with the first and second sub-pad members 116a and 17a exposed by the insulation layer 130 are formed, which are extended along a X-axis direction. The first and second sub-bypass wirings 118 and 119 may include a conductive material. The conductive material may be chromium (Cr), chrome alloys, molybdenum (Mo), molybdenum-nitride (MoN), molybdenum-niobium (MoNb), molybdenum alloy, copper, copper alloy, copper-molybdenum (CuMo) alloy, aluminum (Al), aluminum alloy, silver (Ag), silver alloy, etc. The forming process of the first and second sub-bypass wirings 118 and 119 may be realized by various processes. For example, it may be formed by a photolithograph process, or may by formed by a printing process.

In FIGS. 11A to 11C, it is described that the first and second main connection wirings 114 and 115 contacting to the 3 main sensor 112 is formed when the main sensor 112 is formed; however, the first and second main connection wirings 114 and 115 may be formed in a process forming the first and second sub-bypass wirings 118 and 119. In this case, a hole is formed through the insulation layer 130, so that the main sensor 112 makes contact with the first and second main connection wirings 114 and 115.

FIG. 12 is a plan view schematically illustrating another example of a capacitive touch panel shown in FIG. 1. Particularly, it is shown that the capacitive touch panel has a structure of a plate shape on which holes are not formed.

Referring to FIG. 12, a capacitive touch panel 210 includes a main sensor 112, a sub-sensor 113, an insulation layer 130, first and second main connection wirings 114 and 115, first and second sub-connection wirings 116 and 117, and first and second sub-bypass wirings 118 and 119. The capacitive touch panel 210 shown in FIG. 12 is same as the capacitive touch panel 110 shown in FIG. 10. Thus, the same reference numerals will be used to refer to the same or like parts as those described in FIG. 10, and any further explanation concerning the above elements will be omitted.

The insulation layer 230, which has a structure of a plate shape on which holes are not formed, is formed on the peripheral area PA to expose the first and second sub-pad members 116a and 117a. In the present exemplary embodiment, the insulation layer 230 is formed only in the remaining area except for an area corresponding to the first and second sub-pad members 116a and 117a and a touch area TA, so that an additional process for forming a via hole exposing the first and second sub-pad members 116a and 117b may be omitted.

As described above, according to the present exemplary embodiment, sub-pad members are vertically bent in based on a length direction of the sub-sensor, so that it may secure a contact area between a sub-connection wiring and a sub-pad member even though a width of the sub-pad member is narrow. Accordingly, it may reduce the probability of contact failure between the sub-connection wirings and the sub-pad member.

Moreover, the sub-pad members are vertically bent in based on a length direction of the sub-sensor, so that it may reduce a width of an area on which the sub-pad members are disposed. The area on which the sub-pad members are disposed may correspond to a bezel of a capacitive touch panel. Accordingly, it may reduce a bezel width of a capacitive touch panel.

Moreover, the sub-pad members are disposed in parallel with each other, so that it may reduce a wiring complexity of the sub-bypass wirings making contacting to each of the sub-pad members. Accordingly, it may enhance a signal-to-noise ratio (SNR) of a signal delivered through the sub-bypass wiring and may enhance a work yield.

Moreover, an insulation layer is formed only in the remaining area except for an area corresponding to each of the sub-bypass wirings and each of the sub-pad members during a drawing process, so that an additional process for forming a via hole on the insulation layer may be omitted so that it may reduce a manufacturing cost of a capacitive touch panel.

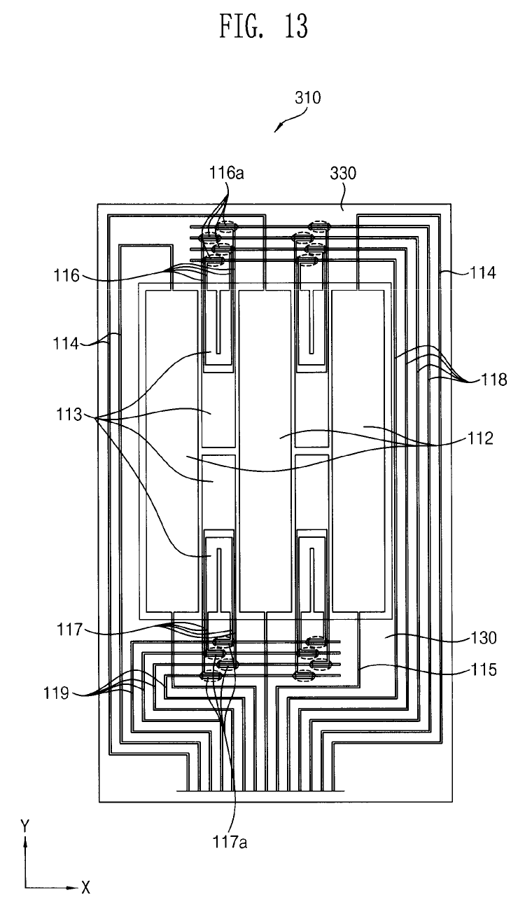

FIG. 13 is a plan view schematically illustrating another example of a capacitive touch panel shown in FIG. 1. Particularly, an example on which holes are formed on an insulation layer is shown.

Referring to FIG. 13, a capacitive touch panel 310 includes a main sensor 112, a sub-sensor 113, an insulation layer 130, first and second main connection wirings 114 and 115, first and second sub-connection wirings 116 and 117, and first and second sub-bypass wirings 118 and 119. The capacitive touch panel 310 shown in FIG. 13 is same as the capacitive touch panel 110 shown in FIG. 10. Thus, the same reference numerals will be used to refer to the same or like parts as those described in FIG. 10, and any further explanation concerning the above elements will be omitted.

The insulation layer 330 is formed on the peripheral area PA to expose the first and second sub-pad members 116a and 117a. In the present exemplary embodiment, the insulation layer 330 is formed only in the remaining area except for an area corresponding to the first and second sub-pad members 116a and 117a and a touch area TA, so that an additional process for forming a via hole exposing the first and second sub-pad members 116a and 117b may be omitted.

As described above, according to the present exemplary embodiment, sub-pad members are vertically bent in based on a length direction of the sub-sensor, so that it may secure a contact area between a sub-connection wiring and a sub-pad member even though a width of the sub-pad member is narrow. Accordingly, it may reduce the probability of contact failure between the sub-connection wirings and the sub-pad member.

Moreover, the sub-pad members are vertically bent in based on a length direction of the sub-sensor, so that it may reduce a width of an area on which the sub-pad members are disposed. The area on which the sub-pad members are disposed may correspond to a bezel of a capacitive touch panel. Accordingly, it may reduce a bezel width of a capacitive touch panel.

Moreover, the sub-pad members are disposed in parallel with each other, so that it may reduce a wiring complexity of the sub-bypass wirings making contacting to each of the sub-pad members. Accordingly, it may enhance a signal-to-noise ratio (SNR) of a signal delivered through the sub-bypass wiring and may enhance a work yield.

Moreover, an insulation layer is formed only in the remaining area except for an area corresponding to each of the sub-bypass wirings and each of the sub-pad members during a drawing process, so that an additional process for forming a via hole on the insulation layer may be omitted so that it may reduce a manufacturing cost of a capacitive touch panel.

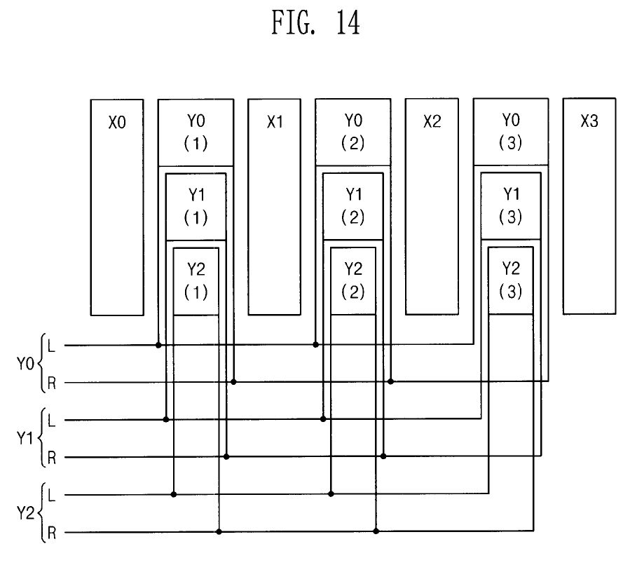

FIG. 14 is a schematic diagram illustrating a touch sensing through a capacitive touch panel shown in FIG. 1.

Referring to FIG. 14, an operation for sensing a X-axis coordinate value of the touch coordinate is performed by using the main sensors X0, X1, X2 and X3. Particularly, after a sensing signal (e.g., Signal_out of FIG. 9A) is outputted to a first side of a main sensor X0 arranged in first column, it receives a sensing signal (e.g., Signal_in of FIG. 9A) through a second side of the corresponding main sensor X0 to sense a capacitance variation. Then, after a sensing signal is outputted to the second side of the main sensor X0 arranged in the first column, it receives a sensing signal through the first side of the corresponding main sensor X0 to sense a capacitance variation.

Then, after a sensing signal is outputted to a first side of a main sensor X1 arranged in second column, it receives a sensing signal through a second side of the corresponding main sensor X1 to sense a capacitance variation. Then, after a sensing signal is outputted to the second side of the main sensor X1 arranged in the second column, it receives a sensing signal through the first side of the corresponding main sensor X1 to sense a capacitance variation.

Then, after a sensing signal is outputted to a first side of a main sensor X2 arranged in third column, it receives a sensing signal through a second side of the corresponding main sensor X2 to sense a capacitance variation. Then, after a sensing signal is outputted to the second side of the main sensor X2 arranged in the third column, it receives a sensing signal through the first side of the corresponding main sensor X2 to sense a capacitance variation.

Then, after a sensing signal is outputted to a first side of a main sensor X3 arranged in fourth column, it receives a sensing signal through a second side of the corresponding main sensor X3 to sense a capacitance variation. Then, after a sensing signal is outputted to the second side of the main sensor X3 arranged in the fourth column, it receives a sensing signal through the first side of the corresponding main sensor X3 to sense a capacitance variation.

In this manner, after outputting the sensing signals through first sides of the main sensors arranged in all the columns, it may detect the X-axis value corresponding to one or more touch coordinates by receiving the sensing signals via the main sensors through second sides of the main sensors to sense a capacitance variation amount of the main sensors.

Then, an operation for sensing a Y-axis coordinate value of the touch coordinate is performed by using the sub-sensors. Particularly, after a sensing signal is outputted to a first side of the sub-sensors Y0(1), Y0(2) and Y0(3) that are disposed at first row to be serially connected to each other, it receives a sensing signal through a second side of the corresponding sub-sensors Y0(1), Y0(2) and Y0(3) to sense a capacitance variation. Then, after a sensing signal is outputted to the second side of the sub-sensors Y0(1), Y0(2) and Y0(3) that are disposed at first row to be serially connected to each other, it receives a sensing signal through the first side of the corresponding sub-sensors Y0(1), Y0(2) and Y0(3) to sense a capacitance variation.

Then, after a sensing signal is outputted to a first side of the sub-sensors Y1(1), Y1(2) and Y1(3) that are disposed at second row to be serially connected to each other, it receives a sensing signal through a second side of the corresponding sub-sensors Y1(1), Y1(2) and Y1(3) to sense a capacitance variation. Then, after a sensing signal is outputted to the second side of the sub-sensors Y1(1), Y1(2) and Y1(3) that are disposed at second row to be serially connected to each other, it receives a sensing signal through the first side of the corresponding sub-sensors Y1(1), Y1(2) and Y1(3) to sense a capacitance variation.

Then, after a sensing signal is outputted to a first side of the sub-sensors Y2(1), Y2(2) and Y2(3) that are disposed at third row to be serially connected to each other, it receives a sensing signal through a second side of the corresponding sub-sensors Y2(1), Y2(2) and Y2(3) to sense a capacitance variation. Then, after a sensing signal is outputted to the second side of the sub-sensors Y2(1), Y2(2) and Y2(3) that are disposed at third row to be serially connected to each other, it receives a sensing signal through the first side of the corresponding sub-sensors Y2(1), Y2(2) and Y2(3) to sense a capacitance variation.

In this manner, after outputting the sensing signals through first sides of the sub-sensors arranged in all the rows, it may detect the Y-axis value corresponding to one or more touch coordinates by receiving the sensing signals via the sub-sensors through second sides of the main sensors to sense a capacitance variation amount of the main sensors.

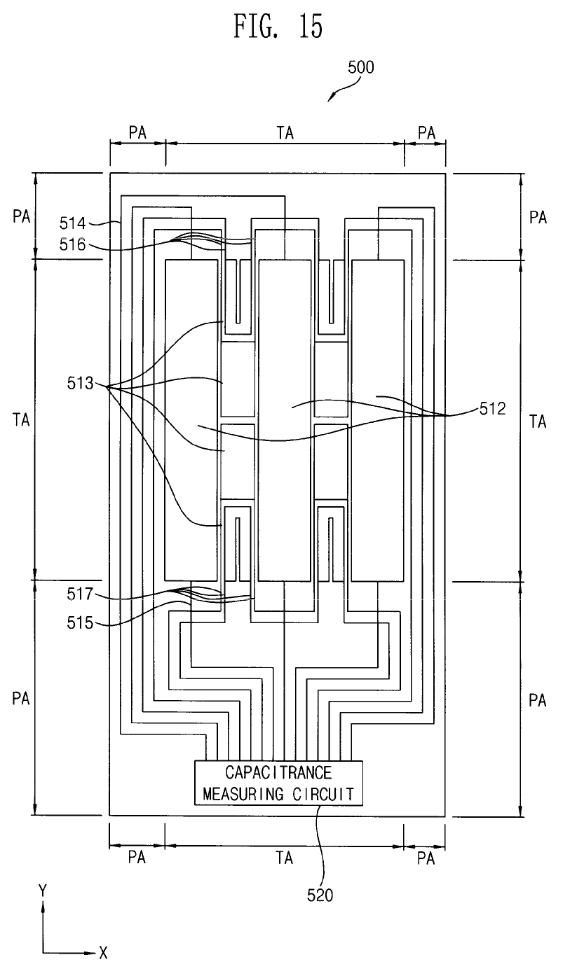

FIG. 15 is a plan view schematically illustrating a capacitive touch apparatus according to another exemplary embodiment of the present invention.

Referring to FIG. 15, the capacitive touch apparatus 500 according to another exemplary embodiment of the present invention includes a capacitive touch panel 510 and a capacitance measuring circuit 520 disposed on the capacitive touch panel 510.

The capacitive touch panel 510 includes a base substrate 511, a plurality of main sensors 512, a plurality of sub-sensors 513 arranged in one-to-plural correspondence in parallel with the main sensors 512, a plurality of first main connection wirings 514, a plurality of second main connection wirings 515, a plurality of first sub-connection wirings 516 and a plurality of second sub-connection wirings 517. The main sensors 512, the sub-sensors 513, the first and second main connection wirings 514 and 515, and the first and second sub-connection wirings 516 and 517 may be formed by a silver material, a metal material, a graphene material, etc. In the present exemplary embodiment, for convenience of description, it is shown that the number of the main sensor 512 is three and the number of sub-sensor 513 is six; however, it is not limited thereto.

The base substrate 511 includes a touch area TA and a peripheral area PA surrounding the touch area TA. In the present exemplary embodiment, the base substrate 511 has a rectangular shape defined by a long side and a short side.

The main sensors 512 are disposed on a touch area TA to sense a touch position of a first axis. Each of the main sensors 512 has a bar shape to be extended along a Y-axis direction and to be arranged along a X-axis direction. Each of the main sensors 512 has a uniform width.

The sub-sensors 513 are arranged in one-to-plural correspondence in parallel with the main sensors 512 to sense a touch position of a second axis. Each of the sub-sensors 513 is disposed between the main sensors 512 adjacent to each other, and is extended along a Y-axis direction to be arranged along a X-axis direction. In order to maintain the same as a resistance value of the different sub-sensors, a slit portion may be formed through an outmost sub-sensor among sub-sensors 113 disposed between the main sensors 112 adjacent to each other. A width of the slit portion and a length of the slip portion may be designed by a designer of a capacitive touch panel. The sub-sensors 113 may be disposed in adjacent to one main sensor. Each width of the sub-sensors 113 may be gradually increased toward a center portion of the capacitive touch panel from an edge portion of the capacitive touch panel.

In the present exemplary embodiment, the first axis may be a X-axis when the second axis is a Y-axis, and the second axis may be a Y-axis when the first axis is a X-axis.

The first main connection wirings 514 are connected to each first end portions of the main sensors 512. The first main connection wirings 514 may include a same material as the main sensors 512. Moreover, the first main connection wirings 514 may be formed when the main sensors 512 are formed.

In the present exemplary embodiment, each of the first main connection wirings 514 may play a role of delivering a sensing signal outputted from the capacitance measuring circuit 520 to each of the main sensors 512, and may play a role of delivering a sensing signal sensed at each of the main sensors 512 to the capacitance measuring circuit 520.

The second main connection wirings 515 are connected to each second end portions of the main sensors 512. The second main connection wirings 515 may include a same material as the main sensors 512. Moreover, the second main connection wirings 515 may be formed when the main sensors 512 are formed.

In the present exemplary embodiment, each of the second main connection wirings 515 may play a role of delivering a sensing signal outputted from the capacitance measuring circuit 520 to each of the main sensors 512, and may play a role of delivering a sensing signal sensed at each of the main sensors 512 to the capacitance measuring circuit 520.

The first sub-connection wirings 516 are connected to a portion of the sub-sensors 513 arranged in a first direction (e.g., a Y-axis direction) and the capacitance measuring circuit 520, respectively. The first sub-connection wirings 516 may include a same material as the sub-sensors 513. Moreover, the first sub-connection wirings 516 may be formed when the sub-sensors 513 are formed.

The second sub-connection wirings 517 are connected to the remaining sub-sensors 513 arranged in the first direction and the capacitance measuring circuit 520, respectively. The second sub-connection wirings 517 may include a same material as the sub-sensors 513. Moreover, the second sub-connection wirings 517 may be formed when the sub-sensors 513 are formed.

In the present exemplary embodiment, it is assumed that an imaginary line is a line perpendicular to a length direction of the main sensor 512 and passing a center area of the main sensor 512, the first sub-connection wiring 516 is connected to each of a first side and a second side of sub-sensors disposed on an upper area in based on the imaginary line, and the second sub-connection line 517 is connected to each of a first side and a second side of sub-sensors disposed on a lower area in based on the imaginary line.

In the present exemplary embodiment, each of the first sub-connection wirings 516 may play a role of delivering a sensing signal outputted from the capacitance measuring circuit 520 to each of the sub-sensors 513, and may play a role of delivering a sensing signal sensed at each of the sub-sensors 513 to the capacitance measuring circuit 520. For example, when the first sub-connection wirings 516 play a role of delivering a sensing signal outputted from the capacitance measuring circuit 520 to each of the sub-sensors 513, the second sub-connection wirings 517 play a role of delivering a sensing signal sensed at the sub-sensor 513 to the capacitance measuring circuit 520. Meanwhile, when the first sub-connection wirings 516 play a role of delivering a sensing signal sensed at the sub-sensor 513 to the capacitance measuring circuit 520, the second sub-connection wirings 517 play a role of delivering a sensing signal outputted from the capacitance measuring circuit 520 to each of the sub-sensors 513.

The capacitance measuring circuit 520 is connected to two end portions of each of the main sensors 512 and the sub-sensors 513 to measure a touch position by sensing a capacitance variation of the main sensors 512 and the sub-sensors 513.

Particularly, the capacitance measuring circuit 520 is connected to the main sensors 512 through the first main connection wirings 514 and the second main connection wirings 515, and is connected to the sub-sensors 513 through the first sub-connection wirings 516 and the second sub-connection wirings 517 to measure a touch position by sensing capacitance variations of the main sensors 512 and the sub-sensors 513.

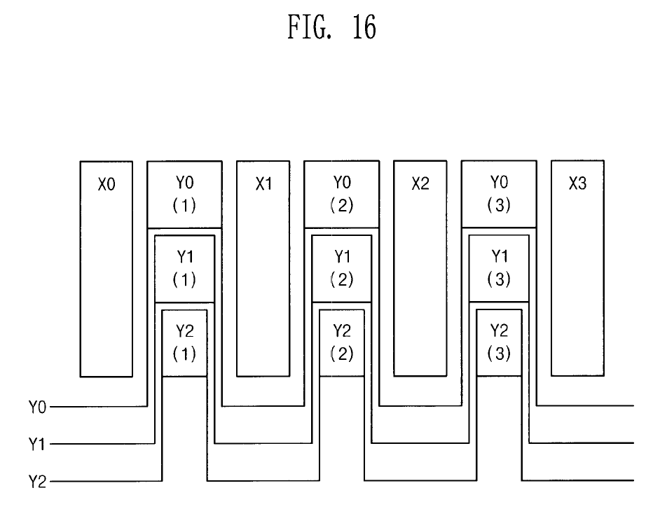

FIG. 16 is a schematic diagram illustrating a touch sensing through a capacitive touch panel shown in FIG. 15.

Referring to FIG. 16, an operation for sensing a X-axis coordinate value of the touch is performed by using the main sensors X0, X1, X2 and X3. Particularly, after a sensing signal (e.g., Signal_out of FIG. 9A) is outputted to a first side of a main sensor X0 arranged in first column, it receives a sensing signal (e.g., Signal_in of FIG. 9A) through a second side of the corresponding main sensor X0 to sense a capacitance variation. Then, after a sensing signal is outputted to the second side of the main sensor X0 arranged in the first column, it receives a sensing signal through the first side of the corresponding main sensor X0 to sense a capacitance variation.

Then, after a sensing signal is outputted to a first side of a main sensor X1 arranged in second column, it receives a sensing signal through a second side of the corresponding main sensor X1 to sense a capacitance variation. Then, after a sensing signal is outputted to the second side of the main sensor X1 arranged in the second column, it receives a sensing signal through the first side of the corresponding main sensor X1 to sense a capacitance variation.

Then, after a sensing signal is outputted to a first side of a main sensor X2 arranged in third column, it receives a sensing signal through a second side of the corresponding main sensor X2 to sense a capacitance variation. Then, after a sensing signal is outputted to the second side of the main sensor X2 arranged in the third column, it receives a sensing signal through the first side of the corresponding main sensor X2 to sense a capacitance variation.

Then, after a sensing signal is outputted to a first side of a main sensor X3 arranged in fourth column, it receives a sensing signal through a second side of the corresponding main sensor X3 to sense a capacitance variation. Then, after a sensing signal is outputted to the second side of the main sensor X3 arranged in the fourth column, it receives a sensing signal through the first side of the corresponding main sensor X3 to sense a capacitance variation.

In this manner, after outputting the sensing signals through first sides of the main sensors arranged in all the columns, it may detect the X-axis value corresponding to one or more touch coordinates by receiving the sensing signals via the main sensors through second sides of the main sensors to sense a capacitance variation amount of the main sensors.

Then, an operation for sensing a Y-axis coordinate value of the touch coordinate is performed by using the sub-sensors. Particularly, after a sensing signal is outputted to a first side of the sub-sensors Y0(1), Y0(2) and Y0(3) that are disposed at first row to be serially connected to each other, it receives a sensing signal through a second side of the corresponding sub-sensors Y0(1), Y0(2) and Y0(3) to sense a capacitance variation. Then, after a sensing signal is outputted to the second side of the sub-sensors Y0(1), Y0(2) and Y0(3) that are disposed at first row to be serially connected to each other, it receives a sensing signal through the first side of the corresponding sub-sensors Y0(1), Y0(2) and Y0(3) to sense a capacitance variation.

Then, after a sensing signal is outputted to a first side of the sub-sensors Y1(1), Y1(2) and Y1(3) that are disposed at second row to be serially connected to each other, it receives a sensing signal through a second side of the corresponding sub-sensors Y1(1), Y1(2) and Y1(3) to sense a capacitance variation. Then, after a sensing signal is outputted to the second side of the sub-sensors Y1(1), Y1(2) and Y1(3) that are disposed at second row to be serially connected to each other, it receives a sensing signal through the first side of the corresponding sub-sensors Y1(1), Y1(2) and Y1(3) to sense a capacitance variation.

Then, after a sensing signal is outputted to a first side of the sub-sensors Y2(1), Y2(2) and Y2(3) that are disposed at third row to be serially connected to each other, it receives a sensing signal through a second side of the corresponding sub-sensors Y2(1), Y2(2) and Y2(3) to sense a capacitance variation. Then, after a sensing signal is outputted to the second side of the sub-sensors Y2(1), Y2(2) and Y2(3) that are disposed at third row to be serially connected to each other, it receives a sensing signal through the first side of the corresponding sub-sensors Y2(1), Y2(2) and Y2(3) to sense a capacitance variation.

In this manner, after outputting the sensing signals through first sides of the sub-sensors serially connected to each other, it may detect the Y-axis value corresponding to one or more touch coordinates by receiving the sensing signals via the sub-sensors serially connected to each other through second sides of the main sensors to sense a capacitance variation amount of the main sensors.

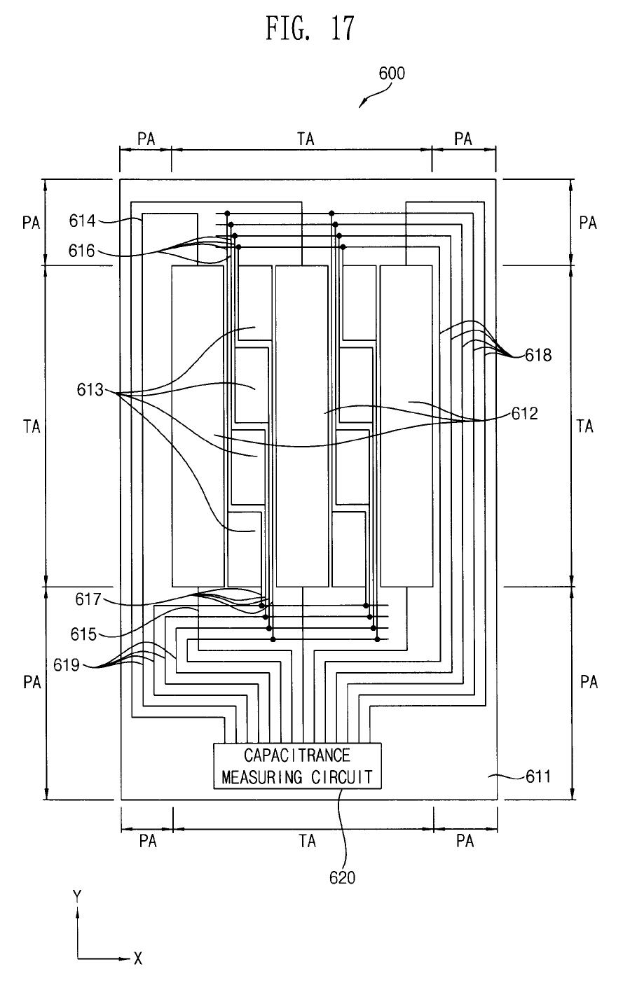

FIG. 17 is a plan view schematically illustrating a capacitive touch apparatus according to another exemplary embodiment of the present invention.

Referring to FIG. 17, the capacitive touch apparatus 600 according to another exemplary embodiment of the present invention includes a capacitive touch panel 610 and a capacitance measuring circuit 620 disposed on the capacitive touch panel 610.

The capacitive touch panel 610 includes a base substrate 611, a plurality of main sensors 612, a plurality of sub-sensors 613 arranged in one-to-plural correspondence in parallel with the main sensors 612, a plurality of first main connection wirings 614, a plurality of second main connection wirings 615, a plurality of first sub-connection wirings 616 and a plurality of second sub-connection wirings 617. The main sensors 612, the sub-sensors 613, the first and second main connection wirings 614 and 615, and the first and second sub-connection wirings 616 and 617 may be formed by a silver material, a metal material, a graphene material, etc. In the present exemplary embodiment, for convenience of description, it is shown that the number of the main sensor 612 is three and the number of sub-sensor 613 is six; however, it is not limited thereto.

The base substrate 611 includes a touch area TA and a peripheral area PA surrounding the touch area TA. In the present exemplary embodiment, the base substrate 611 has a rectangular shape defined by a long side and a short side.

The main sensors 612 are disposed on a touch area TA to sense a touch position of a first axis. Each of the main sensors 612 has a bar shape to be extended along a Y-axis direction and to be arranged along a X-axis direction. Each of the main sensors 612 has a uniform width.

The sub-sensors 613 are arranged in one-to-plural correspondence in parallel with the main sensors 612 to sense a touch position of a second axis. Each of the sub-sensors 613 is disposed between the main sensors 612 adjacent to each other, and is extended along a Y-axis direction to be arranged along a X-axis direction. The sub-sensors 613 disposed between the main sensors 612 adjacent to each other have the same width. When viewed from a plan view of the capacitive touch apparatus 600, each of the sub-sensors 613 is shifted to be disposed thereon.

Although not shown in FIG. 17, in order to maintain the same as a resistance value of the different sub-sensors, a slit portion may be formed through an outmost sub-sensor among sub-sensors 613 disposed between the main sensors 612 adjacent to each other. A width of the slit portion and a length of the slip portion may be designed by a designer of a capacitive touch panel. The sub-sensors 613 may be disposed in adjacent to one main sensor. Each width of the sub-sensors 613 may be gradually increased toward a center portion of the capacitive touch panel from an edge portion of the capacitive touch panel.

In the present exemplary embodiment, the first axis may be a X-axis when the second axis is a Y-axis, and the second axis may be a Y-axis when the first axis is a X-axis.

The first main connection wirings 614 are connected to each first end portions of the main sensors 612. The first main connection wirings 614 may include a same material as the main sensors 612. Moreover, the first main connection wirings 614 may be formed when the main sensors 612 are formed.

In the present exemplary embodiment, each of the first main connection wirings 614 may play a role of delivering a sensing signal outputted from the capacitance measuring circuit 620 to each of the main sensors 612, and may play a role of delivering a sensing signal sensed at each of the main sensors 612 to the capacitance measuring circuit 620.

The second main connection wirings 615 are connected to each second end portions of the main sensors 612. The second main connection wirings 615 may include a same material as the main sensors 612. Moreover, the second main connection wirings 615 may be formed when the main sensors 612 are formed.

In the present exemplary embodiment, each of the second main connection wirings 615 may play a role of delivering a sensing signal outputted from the capacitance measuring circuit 620 to each of the main sensors 612, and may play a role of delivering a sensing signal sensed at each of the main sensors 612 to the capacitance measuring circuit 620.

The first sub-connection wirings 616 are connected to first end portions of each of the sub-sensors 613 and the capacitance measuring circuit 620. The first sub-connection wirings 616 may include a same material as the sub-sensors 613. Moreover, the first sub-connection wirings 616 may be formed when the sub-sensors 613 are formed.

The second sub-connection wirings 617 are connected to second end portions of each of the sub-sensors 613 and the capacitance measuring circuit 620. The second sub-connection wirings 617 may include a same material as the sub-sensors 613. Moreover, the second sub-connection wirings 617 may be formed when the sub-sensors 613 are formed. In the present exemplary embodiment, an extending direction of the first sub-connection wirings 616 and an extending direction of the second sub-connection wirings 617 are opposite to each other. That is, when the first sub-connection wirings 616 are extended along a Y-axis direction, the second sub-connection wirings 617 are extended along a −Y-axis direction.

In the present exemplary embodiment, a first side of a sub-sensor disposed on a line perpendicular to a length direction of the main sensor is connected to the first sub-connection wiring 616, and a second side of a sub-sensor disposed on a line perpendicular to a length direction of the main sensor is connected to the second sub-connection wiring 617. In this case, the first sub-connection wirings 616 are disposed between a sub-sensor connected to the first sub-connection wiring 616 and a main sensor disposed at a left side of the corresponding sub-sensor. Moreover, the second sub-connection wirings 617 are disposed between a sub-sensor connected to the second sub-connection wiring 617 and a main sensor disposed at a right side of the corresponding sub-sensor.

In the present exemplary embodiment, each of the first sub-connection wirings 616 may play a role of delivering a sensing signal outputted from the capacitance measuring circuit 620 to each of the sub-sensors 613, and may play a role of delivering a sensing signal sensed at each of the sub-sensors 613 to the capacitance measuring circuit 620. For example, when the first sub-connection wirings 616 play a role of delivering a sensing signal outputted from the capacitance measuring circuit 620 to each of the sub-sensors 613, the second sub-connection wirings 617 play a role of delivering a sensing signal sensed at the sub-sensor 613 to the capacitance measuring circuit 620. Meanwhile, when the first sub-connection wirings 616 play a role of delivering a sensing signal sensed at the sub-sensor 613 to the capacitance measuring circuit 620, the second sub-connection wirings 617 play a role of delivering a sensing signal outputted from the capacitance measuring circuit 620 to each of the sub-sensors 613.

The capacitance measuring circuit 620 is connected to two end portions of each of the main sensors 612 and the sub-sensors 613 to measure a touch position by sensing a capacitance variation of the main sensors 612 and the sub-sensors 613.

Particularly, the capacitance measuring circuit 620 is connected to the main sensors 612 through the first main connection wirings 614 and the second main connection wirings 615, and is connected to the sub-sensors 613 through the first sub-connection wirings 616 and the second sub-connection wirings 617. The capacitance measuring circuit 620 measures a touch position by sensing capacitance variations of the main sensors 612 and the sub-sensors 613.

As described above, according to the present invention, a capacitance measuring circuit, which is to apply a reference signal to a first side of a touch sensor and to receive a reference signal having a varied voltage due to a resistance and a capacitance formed in the touch sensor when a touch is generate through a second side of the touch sensor, is configured. A resistance difference between the capacitance measuring circuit and the touch sensor is compensated, so that it may reduce a distortion of measured touch time to accurately measure a voltage variation.

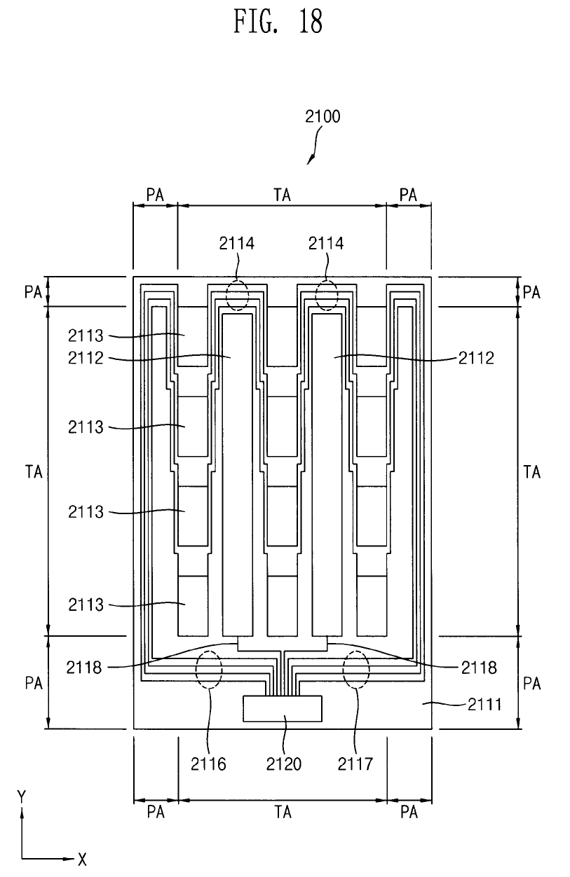

FIG. 18 is a plan view schematically illustrating a capacitive touch apparatus according to another exemplary embodiment of the present invention. Particularly, it is described that main sensors having a length corresponding to a first side of a capacitive touch panel and sub-sensors disposed along one line in parallel with the main sensors are alternatively disposed to define a sensing group.

Referring to FIG. 18, the capacitive touch apparatus 2100 according to another exemplary embodiment of the present invention includes a capacitive touch panel 2110 and a capacitance measuring circuit 2120 disposed on the capacitive touch panel 2110.

The capacitive touch panel 2110 includes a base substrate 2111, a plurality of main sensors 2112, and a plurality of sub-sensors 2113 disposed along one line in adjacent to each of the main sensors 2112. The sub-sensors 2113 are arranged in one-to-plural correspondence in based on one main sensor 2112. In the present exemplary embodiment, the main sensors 2112 and the sub-sensors 2113 disposed along one line are alternatively disposed. That is, a structure on which plural sub-sensors 2113 are disposed along one line in adjacent to one main sensor 2112 is repeated. In the present exemplary embodiment, the sub-sensors 2113 disposed on an imaginary line vertical to a length direction of the main sensor 2112 are connected to each other.

The base substrate 2111 includes a touch area TA and a peripheral area PA surrounding the touch area TA. In the present exemplary embodiment, the base substrate 2111 has a rectangular shape defined by a long side and a short side. The base substrate 2111 may be a ridge type material or a flexible type material.

The main sensors 2112 are disposed on a touch area TA to sense a touch position of a first axis. In the present exemplary embodiment, the first axis may be a X-axis when the second axis is a Y-axis, and the second axis may be a Y-axis when the first axis is a X-axis. Each of the main sensors 2112 has a bar shape to be extended along a Y-axis direction and to be arranged along a X-axis direction. Each of the main sensors 2112 has a uniform width.

The sub-sensors 2113 are arranged in one-to-plural correspondence in parallel with the main sensors 2112 to sense a touch position of a second axis. Each of the sub-sensors 2113 is disposed between the main sensors 2112 adjacent to each other, and is extended along a Y-axis direction to be arranged along a X-axis direction. The sub-sensors 2112 are disposed in adjacent to one main sensor 2112.

The main sensors 2112 and the sub-sensors 2113 may be formed by a metal mesh having a constant resistance per unit area, indium tin oxide (ITO), a silver nano-wire, a carbon nanotubes, etc. Moreover, the main sensors 2112 and the sub-sensors 2113 may be formed by a silver material, a metal material, a graphene material, etc. In the present exemplary embodiment, for convenience of description, it is shown that the number of the main sensor 2112 is two and the number of sub-sensor 2113 disposed along one line is four; however, it is not limited thereto.

The capacitive touch panel 2110 may further include a plurality of sub-connection wirings 2114. Each of the sub-connection wirings 2114 connects to the sub-sensors 2113 disposed on an imaginary line vertical to a length direction of the main sensor 2112. For example, when viewed from FIG. 1, sub-sensors disposed at first row are connected to each other through a first sub-connection wiring (reference numeral is not indicated), sub-sensors disposed at second row are connected to each other through a second sub-connection wiring (reference numeral is not indicated), sub-sensors disposed at third row are connected to each other through a third sub-connection wiring (reference numeral is not indicated), and sub-sensors disposed at fourth row are connected to each other through a fourth sub-connection wiring (reference numeral is not indicated).

The capacitive touch panel 2110 may further include a plurality of first sub-bypass wirings 2116 and a plurality of second sub-bypass wirings 2117 that are disposed at a peripheral area PA.

The first sub-bypass wirings 2116 connect to outmost sub-sensors respectively disposed at a left area of the capacitive touch panel 2110 and the capacitance measuring circuit 2120.

The second sub-bypass wirings 2117 connect to outmost sub-sensors respectively disposed at a right area of the capacitive touch panel 2110 and the capacitance measuring circuit 2120.

The capacitive touch panel 2110 may further include a plurality of main connection wirings 2118 which connect to first end portions of each of the main sensors 2112 and the capacitance measuring circuit 2120.

The capacitance measuring circuit 2120 is connected to two end portions of each of the main sensors 2112 and the sub-sensors 2113 to measure a touch position by sensing a capacitance variation of the main sensors 2112 and the sub-sensors 2113.

In a structure on which sub-sensors disposed at the same row in FIG. 18, the left outmost sub-sensor is connected to the capacitance measuring circuit 2120 through a first sub-bypass wiring 2116, and the right outmost sub-sensor is connected to the capacitance measuring circuit 2120 through a second sub-bypass wiring 2117.

However, the first sub-bypass wiring 2116 and the second sub-bypass wiring 2117 may be omitted or may be not connected to the capacitance measuring circuit 2120 to be physically and electrically floated. When the first sub-bypass wiring 2116 or the second sub-bypass wiring 2117 is not connected to the capacitance measuring circuit 2120 and is physically and electrically floated, a corresponding sub-bypass wiring may be omitted in an area adjacent to the outmost sub-sensor and in an area adjacent to the capacitance measuring circuit 2120.

As described above, according to the present invention, since main sensors, sub-sensors, main connection wirings, sub-connection wirings, first sub-bypass wirings and second sub-bypass wirings are disposed in the same plan, it may realize a capacitive touch panel of a single layer structure.

Moreover, main sensors and sub-sensors are independently connected to each other to realize a capacitive touch panel, so that it may accomplish a multi-touch.

Moreover, one main connection wiring is connected to a main sensor and sub-sensors adjacent to the main sensor are serially connected to each other to be connected to a capacitance measuring circuit, so that it may reduce a wiring complexity in a touch area.

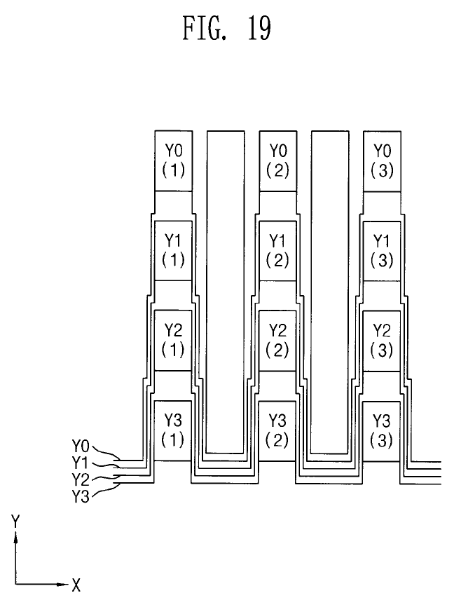

FIG. 19 is a schematic diagram illustrating a touch sensing through a capacitive touch panel shown in FIG. 18.

Referring to FIG. 19, an operation for sensing a X-axis coordinate value of the touch portion is performed by using main sensors X0 and X1.

For example, after a sensing signal is outputted to a first side of a main sensor X0 that is disposed at first column, it receives a sensing signal through sub-sensors Y0(1), Y0(2) and Y0(3) to sense a capacitance variation. Then, after a sensing signal is outputted to a first side of a main sensor X0 that is disposed at second column, it receives a sensing signal through sub-sensors Y0(1), Y0(2) and Y0(3) to sense a capacitance variation.

In this manner, after outputting the sensing signals through first sides of the main sensors arranged in all the columns, it may detect the X-axis value corresponding to one or more touch coordinates by receiving the sensing signals through the sub-sensors Y0(1), Y0(2) and Y0(3) to sense a capacitance variation amount of the main sensors.

Then, an operation for sensing a Y-axis coordinate value of the touch coordinate is performed by using the sub-sensors.

For example, after a sensing signal is outputted to a first side of the sub-sensors Y0(1), Y0(2) and Y0(3) that are disposed at first row to be serially connected to each other, it receives a sensing signal through a second side of the corresponding sub-sensors Y0(1), Y0(2) and Y0(3) to sense a capacitance variation. Then, after a sensing signal is outputted to the second side of the sub-sensors Y0(1), Y0(2) and Y0(3) that are disposed at first row to be serially connected to each other, it receives a sensing signal through the first side of the corresponding sub-sensors Y0(1), Y0(2) and Y0(3) to sense a capacitance variation.

Then, after a sensing signal is outputted to a first side of the sub-sensors Y1(1), Y1(2) and Y1(3) that are disposed at second row to be serially connected to each other, it receives a sensing signal through a second side of the corresponding sub-sensors Y1(1), Y1(2) and Y1(3) to sense a capacitance variation. Then, after a sensing signal is outputted to the second side of the sub-sensors Y1(1), Y1(2) and Y1(3) that are disposed at second row to be serially connected to each other, it receives a sensing signal through the first side of the corresponding sub-sensors Y1(1), Y1(2) and Y1(3) to sense a capacitance variation.

Then, after a sensing signal is outputted to a first side of the sub-sensors Y2(1), Y2(2) and Y2(3) that are disposed at third row to be serially connected to each other, it receives a sensing signal through a second side of the corresponding sub-sensors Y2(1), Y2(2) and Y2(3) to sense a capacitance variation. Then, after a sensing signal is outputted to the second side of the sub-sensors Y2(1), Y2(2) and Y2(3) that are disposed at third row to be serially connected to each other, it receives a sensing signal through the first side of the corresponding sub-sensors Y2(1), Y2(2) and Y2(3) to sense a capacitance variation.

Then, after a sensing signal is outputted to a first side of the sub-sensors Y3(1), Y3(2) and Y3(3) that are disposed at fourth row to be serially connected to each other, it receives a sensing signal through a second side of the corresponding sub-sensors Y3(1), Y3(2) and Y3(3) to sense a capacitance variation. Then, after a sensing signal is outputted to the second side of the sub-sensors Y3(1), Y3(2) and Y3(3) that are disposed at fourth row to be serially connected to each other, it receives a sensing signal through the first side of the corresponding sub-sensors Y3(1), Y3(2) and Y3(3) to sense a capacitance variation.

In this manner, after outputting the sensing signals through first sides of the sub-sensors serially connected to each other, it may detect the Y-axis value corresponding to one or more touch coordinates by receiving the sensing signals via the sub-sensors serially connected to each other through second sides of the main sensors to sense a capacitance variation amount of the main sensors.

In FIG. 19, it is described that a X-coordinate of a touch position is detected in a structure on which a first side of a main sensor is connected to a capacitance measuring circuit. Alternatively, it may also detect a X-coordinate of a touch position in a structure on which first and second sides of a main sensor are connected to a capacitance measuring circuit.

For example, after a sensing signal is outputted to a first side of a main sensor X0 that is disposed at first column, it receives a sensing signal through a second side of the corresponding main sensor X0 to sense a capacitance variation. Then, after a sensing signal is outputted to the second side of the main sensor X0 that is disposed at the first column, it receives a sensing signal through the first side of the corresponding main sensor X0 to sense a capacitance variation.

Then, after a sensing signal is outputted to a first side of a main sensor X1 that is disposed at second column, it receives a sensing signal through a second side of the corresponding main sensor X1 to sense a capacitance variation. Then, after a sensing signal is outputted to the second side of the main sensor X1 that is disposed at the second column, it receives a sensing signal through the first side of the corresponding main sensor X0 to sense a capacitance variation.

In this manner, after outputting the sensing signals through first sides of the main sensors arranged in all the columns, it may detect the X-axis value corresponding to one or more touch coordinates by receiving the sensing signals via the main sensors through second sides of the main sensors to sense a capacitance variation amount of the main sensors.

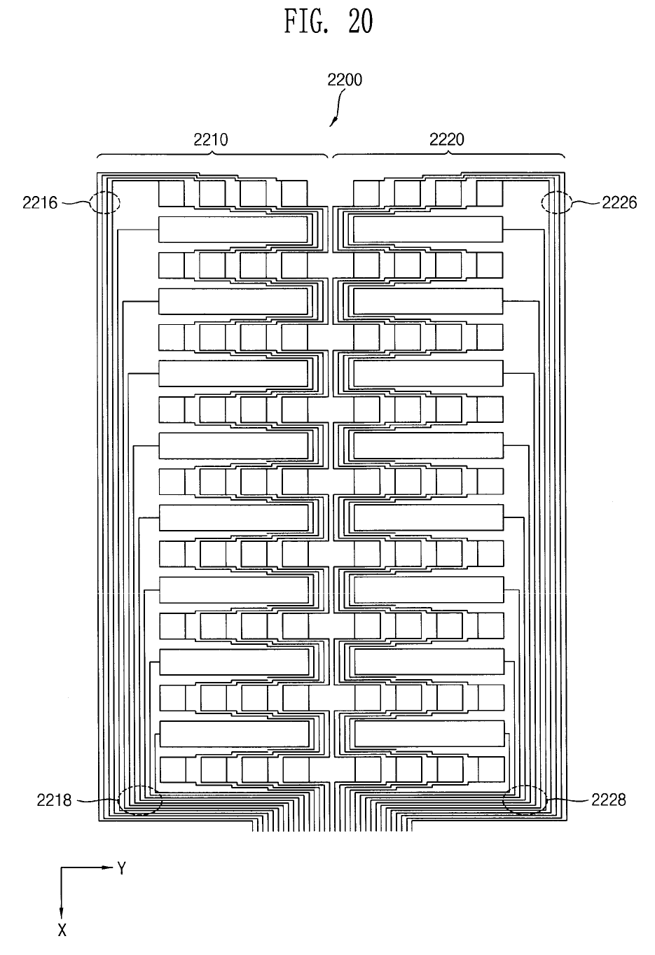

FIG. 20 is a plane diagram schematically illustrating a modification example of a capacitive touch panel shown in FIG. 18.

Referring to FIG. 20, the capacitive touch panel 2200 includes a first sensing group 2210 and a second sensing group 2220 which is mirror symmetrical to the first sensing group 2210. When viewing FIG. 20, the first sensing group 2210 is disposed at a left area of the capacitive touch panel 2200, and the second sensing group 2220 is disposed at a right area of the capacitive touch panel 2200.

The first sensing group 2210 includes a plurality of main sensors extended along a Y-axis direction to be disposed along a X-axis direction, and a plurality of sub-sensors disposed along one line in adjacent to each of the main sensors. When viewing FIG. 20, sub-sensors disposed at the same X-coordinate are connected to each other by a sub-connection wiring. A description of the main sensors and the sub-sensors is described in FIG. 18, so that a detailed description thereof will be omitted.

The second sensing group 2220 includes a plurality of main sensors extended along a Y-axis direction to be disposed along a X-axis direction, and a plurality of sub-sensors disposed along one line in adjacent to each of the main sensors. When viewing FIG. 20, sub-sensors disposed at the same X-coordinate are connected to each other by a sub-connection wiring. A disposing structure of the main sensors and the sub-sensors disposed in the second sensing group 2220 and a disposing structure of the main sensors and the sub-sensors disposed in the first sensing group 2210 are symmetric right and left.

In the present exemplary embodiment, first sub-bypass wirings 2216 respectively connected to outmost sub-sensors of the first sensing group 2210 detecting the same X-coordinate and second sub-bypass wirings 2226 respectively connected to outmost sub-sensors of the second sensing group 2220 may be independently connected to a capacitance measuring circuit 2120 (shown in FIG. 18). Alternatively, first sub-bypass wirings 2216 respectively connected to outmost sub-sensors of the first sensing group 2210 detecting the same X-coordinate and second sub-bypass wirings 2226 respectively connected to outmost sub-sensors of the second sensing group 2220 may be commonly connected to each other to be connected to a capacitance measuring circuit 2120 (shown in FIG. 18).

In the present exemplary embodiment, first main bypass wirings 2218 respectively connected to main sensors of the first sensing group 2210 detecting the same Y-coordinate and second main bypass wirings 2228 respectively connected to main sensors of the second sensing group 2220 may be independently connected to a capacitance measuring circuit 2120 (shown in FIG. 18). Alternatively, first main bypass wirings 2218 respectively connected to main sensors of the first sensing group 2210 detecting the same Y-coordinate and second main bypass wirings 2228 respectively connected to main sensors of the second sensing group 2220 may be commonly connected to each other to be connected to a capacitance measuring circuit 2120 (shown in FIG. 18).

In FIG. 20, it is shown that a first sensing group 2210 for detecting a touch position of a left area of a capacitance touch panel 2200 and a second sensing group 2220 for detecting a touch position of a right area of a capacitance touch panel 2200 are symmetric right and left.

However, four sensing groups may be disposed on a capacitive touch panel. For example, a first sensing group for detecting a touch position corresponding to a first quadrant area of a capacitive touch panel may be disposed on a first quadrant, a second sensing group for detecting a touch position corresponding to a second quadrant area of a capacitive touch panel may be disposed on a second quadrant, a third sensing group for detecting a touch position corresponding to a third quadrant area of a capacitive touch panel may be disposed on a third quadrant, and a fourth sensing group for detecting a touch position corresponding to a fourth quadrant area of a capacitive touch panel may be disposed on a fourth quadrant.

In FIG. 20, it is shown that first sub-bypass wirings respectively connected to outmost sub-sensors of a first sensing group 2210 disposed at a left area and second sub-bypass wirings respectively connected to outmost sub-sensors of a second sensing group 2220 disposed at a right area are disposed to be connected to a capacitance measuring circuit (not shown).

However, first sub-bypass wirings corresponding to the first sensing group 2210 or second sub-bypass wirings corresponding to the second sensing group 2220 are not connected to the capacitance measuring circuit to be electrically or physically floated from the capacitance measuring circuit. When the first sub-bypass wirings or the second sub-bypass wirings are not connected to the capacitance measuring circuit to be electrically or physically floated from the capacitance measuring circuit, a corresponding sub-bypass wiring may be omitted in an area adjacent to a corresponding outmost sub-sensor or in an area adjacent to the capacitance measuring circuit.

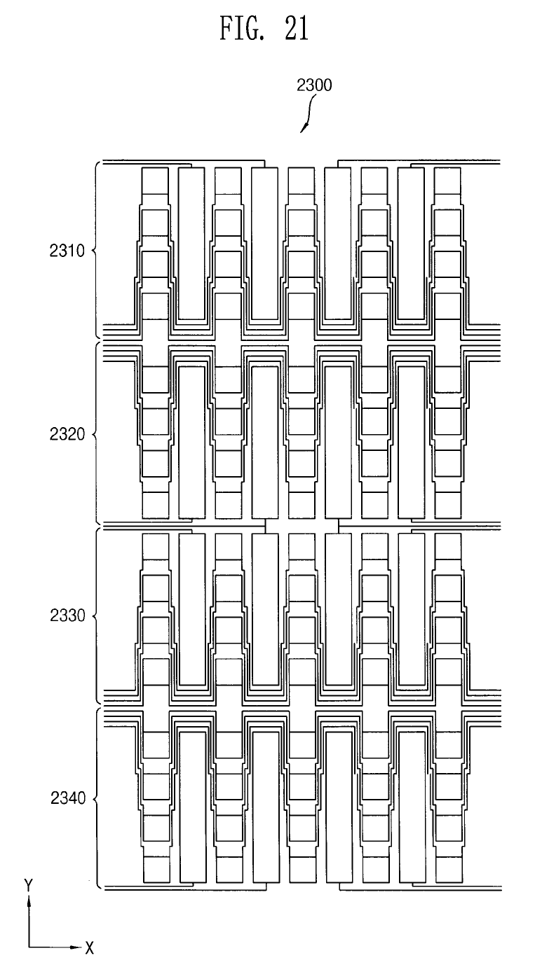

FIG. 21 is a plane diagram schematically illustrating a modification example of a capacitive touch panel shown in FIG. 18.

Referring to FIG. 21, the capacitive touch panel 2300 includes a first sensing group 2310, a second sensing group 2320, a third sensing group 2330 and a fourth sensing group 2340. When viewing FIG. 21, the first sensing group 2310 is disposed at an upper portion of an upper area of the capacitive touch panel 2300, the second sensing group 2320 is disposed at a lower portion of an upper area of the capacitive touch panel 2300, the third sensing group 2330 is disposed at an upper portion of a lower area of the capacitive touch panel 2300, and the fourth sensing group 2340 is disposed at a lower portion of a lower area of the capacitive touch panel 2300.

Main sensors, sub-sensors, main connection wirings, sub-connection wirings and sub-bypass wirings are disposed on each of the second and fourth sensing groups 2320 and 2340 in a disposing structure described in FIG. 18.

Main sensors, sub-sensors, main connection wirings, sub-connection wirings and sub-bypass wirings are disposed on each of the first and third sensing groups 2310 and 2330 in a disposing structure which is symmetry horizontally disposed in based on a disposing structure described in FIG. 18.

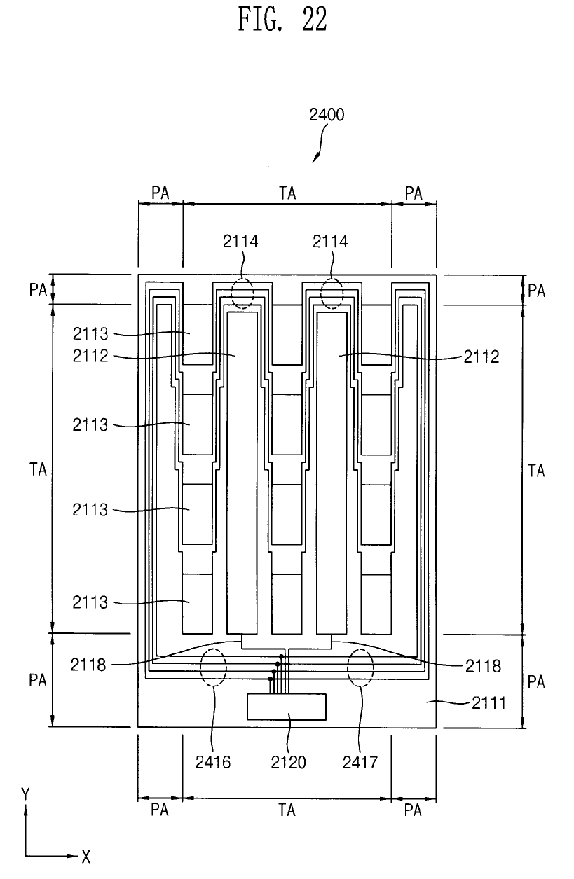

FIG. 22 is a plane diagram schematically illustrating a capacitive touch apparatus according to another exemplary embodiment of the present invention.

Referring to FIG. 22, the capacitive touch apparatus 2400 according to another exemplary embodiment of the present invention includes a capacitive touch panel 2110 and a capacitance measuring circuit 2120 disposed on the capacitive touch panel 2110.

The capacitive touch apparatus 2400 shown in FIG. 22 is substantially the same as the capacitive touch apparatus 2400 shown in FIG. 18 except for a structure of first and second sub-bypass wirings 2416 and 2417 connected to a capacitance measuring circuit 2120. Thus, identical reference numerals are used in FIG. 22 to refer to components that are the same or like those shown in FIG. 18, and thus, a detailed description thereof will be omitted. That is, in similar to the capacitive touch panel 2110 shown in FIG. 18, in a capacitive touch panel 2110 shown in FIG. 22, the main sensors 2112 and the sub-sensors 2113 disposed along one line are alternately arranged. That is, a structure on which a plurality of sub-sensors 2113 is disposed along one line in adjacent to one main sensor 2112 is repeated.

In FIG. 18, each of the first and second sub-bypass wirings 2116 and 2117 is independently connected to a capacitance measuring circuit 2120 in order to sense a touch position in a self capacitance method. That is, a first sub-sensor and the last sub-sensor of sub-sensors serially connected to each other are the different ports of the capacitance measuring circuit 2120 to sense a touch position in a self capacitance method.

Alternatively, in FIG. 22, the first sub-bypass wirings 2416 and the second sub-bypass wirings 2417 are commonly connected to each other and are connected to a capacitance measuring circuit 2120 in order to sense a touch position in a mutual capacitance method. For example, a first sub-bypass wiring connected to a left sub-sensor corresponding to first row and a second sub-bypass wiring connected to a right sub-sensor corresponding to first row are commonly connected to each other and are connected to a capacitance measuring circuit 2120. A first sub-bypass wiring connected to a left sub-sensor corresponding to second row and a second sub-bypass wiring connected to a right sub-sensor corresponding to second row are commonly connected to each other and are connected to a capacitance measuring circuit 2120. A first sub-bypass wiring connected to a left sub-sensor corresponding to third row and a second sub-bypass wiring connected to a right sub-sensor corresponding to third row are commonly connected to each other and are connected to a capacitance measuring circuit 2120. A first sub-bypass wiring connected to a left sub-sensor corresponding to fourth row and a second sub-bypass wiring connected to a right sub-sensor corresponding to fourth row are commonly connected to each other and are connected to a capacitance measuring circuit 2120.

That is, the first and last sub-sensor of a column direction of sub-sensors serially connected to each other are commonly connected to the capacitance measuring circuit 2120 to sense a touch position in a mutual capacitance method.

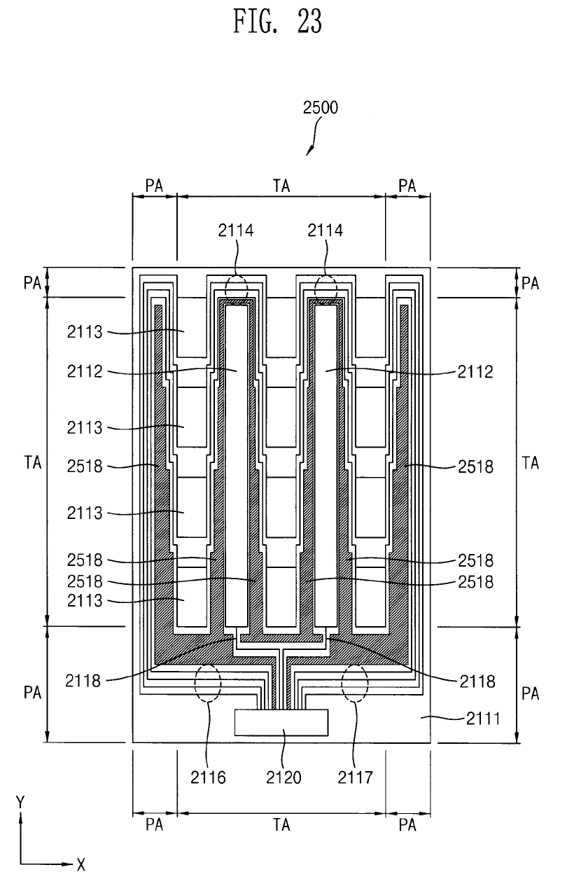

FIG. 23 is a plane diagram schematically illustrating a capacitive touch apparatus according to another exemplary embodiment of the present invention.

Referring to FIG. 23, the capacitive touch apparatus 2500 according to another exemplary embodiment of the present invention includes a capacitive touch panel 2110 and a capacitance measuring circuit 2120 disposed on the capacitive touch panel 2110.

The capacitive touch apparatus 2500 shown in FIG. 23 is same as the capacitive touch apparatus 2100 shown in FIG. 18 except for a ground member 2518. Thus, the same reference numerals will be used to refer to the same or like parts as those described in FIG. 18, and any further explanation concerning the above elements will be omitted.

The ground member 2518 is disposed between a sub-connection wiring 2114 closest to the main sensor 2112 and the main sensor 2112. The ground member 2518 prevents a coupling capacitance from being generated between the main sensor 2112 and the sub-connection wiring 2114. Accordingly, it may enhance a touch sensitivity of a capacitive touch panel. In the present exemplary embodiment, the ground member 2518 may be formed by a metal mesh having a constant resistance per unit area, indium tin oxide (ITO), a silver nano-wire, a carbon nanotubes, etc. Moreover, the ground member 2518 may be formed by a silver material, a metal material, a graphene material, etc.

Moreover, the ground member 2518 is disposed between a first sub-bypass wiring 2116 and a sub-connection wiring 2114 disposed at a left area of the capacitive touch panel 2110. The ground member 2518 prevents a coupling capacitance from being generated between the first sub-bypass wirings 2116 and a sub-connection wiring 2114 disposed at a left area thereof. Accordingly, it may enhance a touch sensitivity of a capacitive touch panel.

Moreover, the ground member 2518 is disposed between a second sub-bypass wiring 2116 and a sub-connection wiring 2114 disposed at a right area of the capacitive touch panel 2110. The ground member 2518 prevents a coupling capacitance from being generated between the second sub-bypass wirings 2117 and a sub-connection wiring 2114 disposed at a right area thereof. Accordingly, it may enhance a touch sensitivity of a capacitive touch panel.

The ground member 2518 receives a ground voltage from the capacitance measuring circuit 2120. In FIG. 23, it is described that the ground member 2518 is connected to two ports of the capacitance measuring circuit 2120 to receive a ground voltage. Alternatively, the ground member 2518 may be connected to one port of the capacitance measuring circuit 2120.

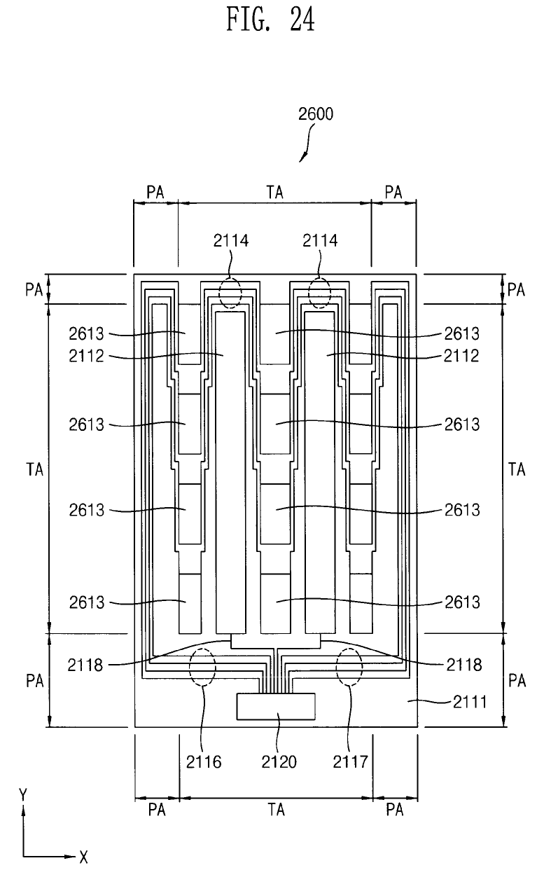

FIG. 24 is a plane diagram schematically illustrating a capacitive touch apparatus according to another exemplary embodiment of the present invention.

Referring to FIG. 24, the capacitive touch apparatus 2600 according to another exemplary embodiment of the present invention includes a capacitive touch panel 2110 and a capacitance measuring circuit 2120 disposed on the capacitive touch panel 2110.

The capacitive touch apparatus 2600 shown in FIG. 23 is same as the capacitive touch apparatus 2100 shown in FIG. 18 except that a width of sub-sensors 2613 disposed at an outmost area of the capacitive touch apparatus 2600 is narrower than a width of sub-sensors 2113 disposed at an outmost area of the capacitive touch apparatus 2100. Thus, the same reference numerals will be used to refer to the same or like parts as those described in FIG. 18, and any further explanation concerning the above elements will be omitted.

In the present exemplary embodiment, a width of the sub-sensors 2613 disposed at the outmost area is substantially a half of that of the sub-sensors 2613 disposed at the remaining area.

That is, sub-sensors disposed at the outmost area of a left area correspond to one main sensor, and sub-sensors disposed at the outmost area of a right area correspond to one main sensor. On the other hand, sub-sensors disposed on the remaining area correspond to two main sensors.

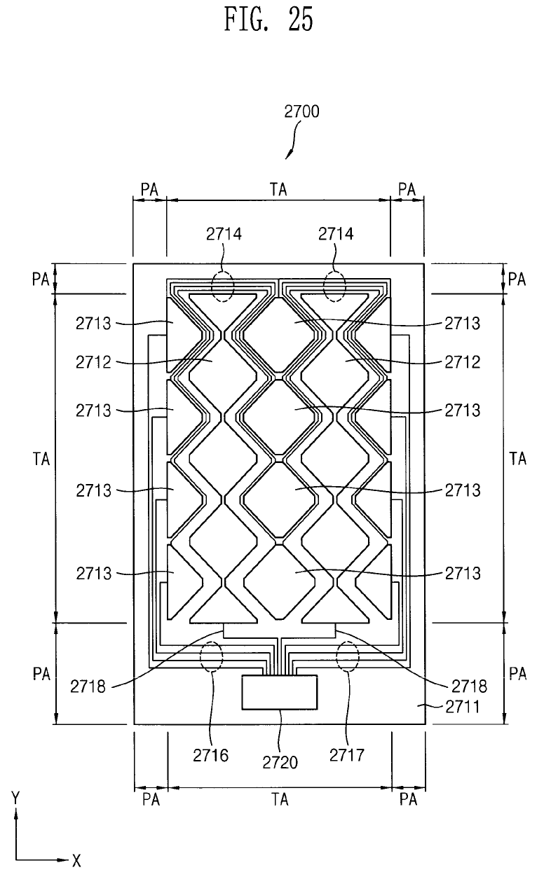

FIG. 25 is a plane diagram schematically illustrating a capacitive touch apparatus according to another exemplary embodiment of the present invention.

Referring to FIG. 25, the capacitive touch apparatus 2700 according to another exemplary embodiment of the present invention includes a capacitive touch panel 2710 and a capacitance measuring circuit 2720 disposed on the capacitive touch panel 2710.

The capacitive touch panel 2710 includes a base substrate 2711, a plurality of main sensors 2712, and a plurality of sub-sensors 2713 disposed along one line in adjacent to each of the main sensors 2712. The sub-sensors 2713 are arranged in one-to-plural correspondence in based on one main sensor 2712. In the present exemplary embodiment, the sub-sensors 2713 disposed on an imaginary line vertical to a length direction of the main sensor 2712 are connected to each other. That is, in FIG. 25, sub-sensors corresponding to the same Y coordinate value are connected to each other.

The base substrate 2711 includes a touch area TA and a peripheral area PA surrounding the touch area TA. In the present exemplary embodiment, the base substrate 2711 has a rectangular shape defined by a long side and a short side. The base substrate 2711 may be a ridge type material or a flexible type material.

The main sensors 2712 are disposed on a touch area TA to sense a touch position of a first axis. The first axis may be a X-axis when the second axis is a Y-axis, and the second axis may be a Y-axis when the first axis is a X-axis. In the present exemplary embodiment, the main sensors 2712 detect a X coordinate value. The main sensors 2712 have a shape on which plural diamonds are serially connected to each other. Meanwhile, the main sensors 2712 adjacent to a peripheral area PA may have a triangular shape.

The sub-sensors 2713 are disposed in one-to-plural correspondence in parallel with the main sensors 2712 to sense a touch position of a second axis. In the present exemplary embodiment, the sub-sensors 2713 detect a Y coordinate value. Each of the sub-sensors 2713 is disposed between the main sensors 2712 adjacent to each other, and is extended along a Y-axis direction to be arranged along a X-axis direction. The sub-sensors 2713 are disposed adjacent to one main sensor 2712. The sub-sensors 2713 have a diamond shape. Meanwhile, the sub-sensors 2713 adjacent to a peripheral area PA may have a triangular shape.

The main sensors 2712 and the sub-sensors 2713 may be formed by indium tin oxide (ITO), a metal mesh, a silver nano-wire, a carbon nanotubes, etc. Moreover, the main sensors 2712 and the sub-sensors 2713 may be formed by a silver material, a metal material, a graphene material, etc. In the present exemplary embodiment, for convenience of description, it is shown that the number of the main sensor 2712 is two and the number of sub-sensor 2713 disposed along one line is four; however, it is not limited thereto.

The capacitive touch panel 2710 may further include a plurality of sub-connection wirings 2714. Each of the sub-connection wirings 2714 connects to the sub-sensors 2713 disposed on an imaginary line vertical to a length direction of the main sensor 2712. For example, when viewed from FIG. 1, sub-sensors disposed at first row are connected to each other through a first sub-connection wiring (reference numeral is not indicated), sub-sensors disposed at second row are connected to each other through a second sub-connection wiring (reference numeral is not indicated), sub-sensors disposed at third row are connected to each other through a third sub-connection wiring (reference numeral is not indicated), and sub-sensors disposed at fourth row are connected to each other through a fourth sub-connection wiring (reference numeral is not indicated).

The capacitive touch panel 2710 may further include a plurality of first sub-bypass wirings 2716 and a plurality of second sub-bypass wirings 2717 that are disposed at a peripheral area PA.

The first sub-bypass wirings 2716 connect to outmost sub-sensors respectively disposed at a left area of the capacitive touch panel 2710 and the capacitance measuring circuit 2720.

The second sub-bypass wirings 2717 connect to outmost sub-sensors respectively disposed at a right area of the capacitive touch panel 2710 and the capacitance measuring circuit 2720.

The capacitive touch panel 2710 may further include a plurality of main connection wirings 2718 which connect to first end portions of each of the main sensors 2712 and the capacitance measuring circuit 2720.

The capacitance measuring circuit 2720 is connected to two end portions of each of the main sensors 2712 and the sub-sensors 2713 to measure a touch position by sensing a capacitance variation of the main sensors 512 and the sub-sensors 2713.

As described above, according to the present invention, since main sensors having a shape on which plural diamonds are serially connected to each other is disposed as a layer identical to sub-sensors having a diamond shape, it is possible to prevent moire phenomenon which may be caused by misalignment between a capacitive touch panel and a display panel disposed below the capacitive touch panel.

Moreover, since main sensors having a shape on which plural diamonds are serially connected to each other, sub-sensors having a diamond shape, main connection wirings, sub-connection wirings, first sub-bypass wirings and second sub-bypass wirings are disposed in the same plane, it may realize a capacitive touch panel of a single layer structure.

Moreover, main sensors having a shape on which plural diamonds are serially connected to each other and sub-sensors having a diamond shape are independently connected to each other to realize a capacitive touch panel, so that it may accomplish a multi-touch.

Moreover, one main connection wiring is connected to a main sensor and sub-sensors adjacent to the main sensor are serially connected to each other to be connected to a capacitance measuring circuit, so that it may reduce a wiring complexity in a touch area.

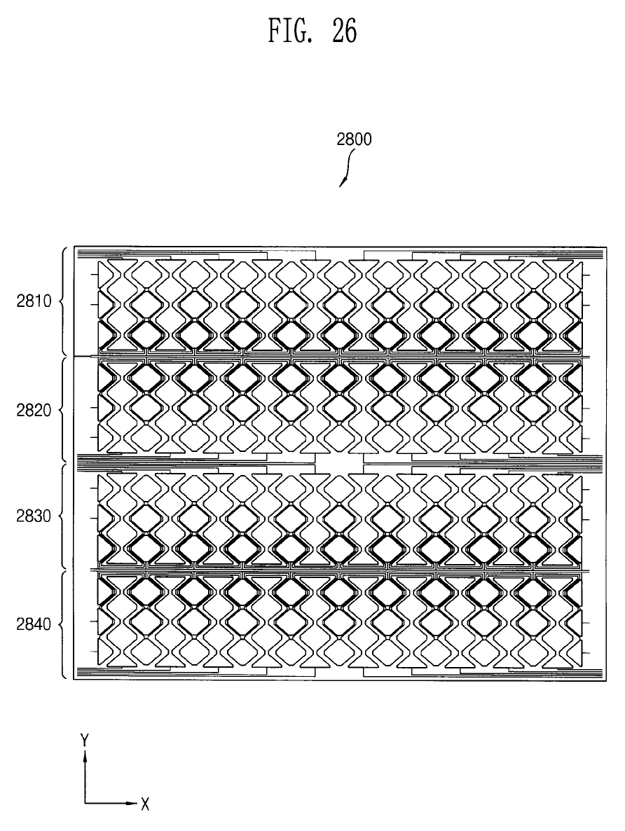

FIG. 26 is a plane diagram schematically illustrating a modification example of a capacitive touch panel shown in FIG. 25.

Referring to FIG. 26, the capacitive touch panel 2800 includes a first sensing group 2810, a second sensing group 2820, a third sensing group 2830 and a fourth sensing group 2840 that are sequentially disposed along a −Y-axis direction.

The first sensing group 2810 includes, as description in FIG. 25, main sensors alternatively disposed and sub-sensors disposed along one line. That is, the main sensor is defined by diamond shapes serially connected to each other and are disposed in parallel with a Y-axis direction, and each of the sub-sensors is defined by each diamond shapes disposed in parallel with a Y-axis direction.

In main connection wirings connected to each upper side of the main sensors, main connection wirings disposed at a left area are extended in a left direction, and main connection wirings disposed at a right area are extended in a right direction.

In sub-connection wirings connected to each of the sub-sensors to be extended along a lower direction, sub-connection wirings disposed at a left area are extended in a left direction, and sub-connection wirings disposed at a right area are extended in a right direction.

The second sensing group 2820 includes main sensors alternatively disposed and sub-sensors disposed along one line. That is, a structure on which plural sub-sensors are disposed along one line in adjacent to one main sensor is repeated. In the present exemplary embodiment, the sub-sensors disposed on an imaginary line vertical to a length direction of the main sensor are connected to each other.

Moreover, the second sensing group 2320 includes main connection wirings and sub-connection wirings. A disposing structure of main sensors, sub-sensors, main connection wirings and sub-connection wirings disposed on the second sensing group 2820 is symmetry horizontally disposed to a disposing structure of main sensors, sub-sensors, main connection wirings and sub-connection wirings disposed on the first sensing group 2810.

A disposing structure of main sensors, sub-sensors, main connection wirings and sub-connection wirings disposed on the third sensing group 2830 is symmetry horizontally disposed to a disposing structure of main sensors, sub-sensors, main connection wirings and sub-connection wirings disposed on the second sensing group 2820. Thus, a detailed description concerning the third sensing group 2830 will be omitted.

A disposing structure of main sensors, sub-sensors, main connection wirings and sub-connection wirings disposed on the fourth sensing group 2840 is symmetry horizontally disposed to a disposing structure of main sensors, sub-sensors, main connection wirings and sub-connection wirings disposed on the third sensing group 2830. Thus, a detailed description concerning the fourth sensing group 2840 will be omitted.

As described above, according to the present invention, since main sensors, sub-sensors, main connection wirings, sub-connection wirings, first sub-bypass wirings and second sub-bypass wirings are disposed in the same plan, it may realize a capacitive touch panel of a single layer structure.

Moreover, main sensors and sub-sensors are independently connected to each other to realize a capacitive touch panel, so that it may accomplish a multi-touch.

Moreover, one main connection wiring is connected to a main sensor and sub-sensors adjacent to the main sensor are serially connected to each other to be connected to a capacitance measuring circuit, so that it may reduce a wiring complexity in a touch area.

Having described exemplary embodiments of the present invention, it is further noted that it is readily apparent to those of reasonable skill in the art that various modifications may be made without departing from the spirit and scope of the invention which is defined by the metes and bounds of the appended claims.

As described above, according to the present invention, a capacitance measuring circuit, which is to apply a reference signal to a first side of a touch sensor and to receive a reference signal having a varied voltage due to a resistance and a capacitance formed in the touch sensor when a touch is generate through a second side of the touch sensor, is configured. A resistance difference between the capacitance measuring circuit and the touch sensor is compensated, so that it may reduce a distortion of measured touch time to accurately measure a voltage variation.

Moreover, a capacitive touch panel according to the present invention may be mounted on various products such as a sensing device sensing a touch position to be applicable. Touch screen type products are widely used in various fields of industry and are rapidly replacing button type devices due to their superior spatial characteristics. The most explosive demand is in the field of cell phones. In particular, in cell phones, convenience and the size of a terminal are very significant and thus, touch phones that do not include additional keys or minimize the number of keys have recently come into the spotlight. Thus, a sensing device having a capacitance type touch pattern according to the present invention mounted thereon may be employed in a cell phone and can also be widely used in a television (TV) including a touch screen, an asynchronous transfer mode (ATM) device that automatically serves cash withdrawal and remittance of a bank, an elevator, a ticket machine used in a subway, a portable multimedia player (PMP), an e-book, a navigation device, and the like. Besides, the touch display device replaces a general button type interface in all fields that require a user interface.

[Description of reference numerals]

| | |
|---|---|
| 110, 310, 510, 610, 2110, 2710: a capacitive touch panel | |
| 111, 511, 611, 2111, 2711: a base substrate | |
| 112, 512, 612, 2112, 2712: a main sensor | |
| 113, 513, 613, 2113, 2713: sub-sensors | |
| 114, 514, 614: a first main connection wiring | |
| 115, 515, 615: a second main connection wiring | |
| 116, 516, 616: a first sub-connection wiring | |
| 117, 517, 617: a second sub-connection wiring | |
| 118, 2116, 2416: a first sub-bypass wiring | |
| 119, 2117, 2417: a second sub-bypass wiring | |
| 120, 520, 620, 2120, 2720: a capacitance measuring circuit | |
| 1410: reference voltage generating part | 1420: a voltage comparing part |
| 1430: a control part | 1440: a timer part |
| 1450, 1550: a charging/discharging part | 1452: a charging part |
| 1454: a discharging part | 1460: a complex switch |
| 1462: a first switch | 1464: a second switch |
| 1640: a discharging control part | 1610, SW: a charging/discharging switch |
| 1620: a first current mirror | 1630: a second current mirror |
| 1650: a discharging part | 1660: a third current mirror |
| 1670:, a charging control part | 1680: a charging part |
| TA: a touch area | PA: a peripheral area |
| 2210, 2310, 2810: a first sensing group | 2220, 2320, 2820: a second sensing group |
| 2218: a first main bypass wiring | 2228: a second main bypass wiring |
| 2330, 2830: a third sensing group | 2340, 2840: a fourth sensing group |
| 2518: a ground member | |

1. A capacitive touch panel comprising:
a base substrate comprising a touch area and a peripheral area surrounding the touch area;
a plurality of main sensors disposed on the touch area;
a plurality of sub-sensors disposed along one line adjacent to each of the main sensors, the sub-sensors disposed in one-to-plural correspondence with respect to one main sensor;
a plurality of main connection wirings connected to first side of the main sensors, respectively; and
a plurality of sub-connection wirings connecting to sub-sensors disposed on an imaginary line perpendicular to a length direction of the main sensor,
wherein the sub-sensors disposed on an imaginary line vertical to a length direction of the main sensor are connected to each other, and
the main sensors, the sub-sensors and the sub-connection wirings are disposed to define a single layer structure.

2. The capacitive touch panel of claim 1, wherein the main sensor and sub-sensors disposed along one line are alternately arranged.

3. The capacitive touch panel of claim 1, wherein sub-sensors disposed in parallel with the main sensor are only disposed along one line.

4. (canceled)

5. (canceled)

6. The capacitive touch panel of claim 1, further comprising:
a ground member disposed between a sub-connection wiring adjacent to the main sensor and the main sensor.

7. (canceled)

8. The capacitive touch panel of claim 1, wherein a width of sub-sensors disposed at an outmost area is substantially equal to a width of sub-sensors disposed at a remaining area.

9. The capacitive touch panel of claim 1, wherein a width of sub-sensors disposed at an outmost area is narrower than a width of sub-sensors disposed at a remaining area.

10. The capacitive touch panel of claim 1, further comprising:
a plurality of sub-bypass wirings disposed at the peripheral area to be connected to each outmost sub-sensor of the sub-sensors in one-to-one correspondence.

11. The capacitive touch panel of claim 1, wherein each of the main sensors has a bar shape, and each of the sub-sensors has a rectangular shape.

12. The capacitive touch panel of claim 1, wherein each of the main sensors has a shape on which plural diamonds are serially connected to each other, and each of the sub-sensors has a diamond shape.

13. The capacitive touch panel of claim 1, wherein each sub-sensors disposed on the same row of sub-sensors serially connected to each other is connected to the different ports of a capacitance measuring circuit to sense a touch position in a self-capacitance method.

14. The capacitive touch panel of claim 1, wherein each sub-sensors disposed on the same row of sub-sensors serially connected to each other is commonly connected to a capacitance measuring circuit to sense a touch position in a mutual capacitance method.

15. A capacitive touch panel comprising:
a plurality of main sensors disposed on a touch area;
a plurality of sub-sensors formed on a layer on which the main sensors are formed to be arranged along the first direction in one-to-plural correspondence in parallel with the main sensors;
a plurality of first main connection wirings connected to first sides of the main sensors;
a plurality of second main connection wirings connected to second sides of the main sensors;
a plurality of first sub-connection wirings connected to a portion of sub-sensors arranged along the first direction and extended along an upper direction when viewed from a plan view; and
a plurality of second sub-connection wirings connected to a portion of sub-sensors or the remaining sub-sensors and extended along a lower direction when viewed from a plan view,
wherein the first sub-connection wirings or the second sub-connection wirings, which are connected to a predetermined sub-sensor, are extended in the same direction.

16. The capacitive touch panel of claim 15,
wherein a portion on which the first main connection wiring and the main sensor are connected to each other and a portion on which the second main connection wiring and the main sensor are connected to each other are faced to each other.

17. The capacitive touch panel of claim 15, wherein each width of the sub-sensors is gradually decreased toward a peripheral portion of the touch area from a center portion of the touch area.

18. The capacitive touch panel of claim 15, wherein a slit portion is formed through an outmost sub-sensor among sub-sensors disposed between the main sensors adjacent to each other.

19. The capacitive touch panel of claim 15, wherein plural sub-sensors disposed on an imaginary line perpendicular to a length direction of the main sensor are connected in parallel with each other.

20. The capacitive touch panel of claim 15, wherein plural sub-sensors disposed on an imaginary line perpendicular to a length direction of the main sensor are connected in serial with each other.

21. The capacitive touch panel of claim 15, wherein the sub-sensors disposed between the main sensors adjacent to each other have the same width, and each of the sub-sensors is shifted to be disposed thereon when viewed from a plan view.

22. (canceled)

23. The capacitive touch panel of claim 15,
a plurality of first sub-bypass wirings disposed on a peripheral area surrounding the touch area to be connected to each of the first sub-connection wiring in one-to-one correspondence; and
a plurality of second sub-bypass wirings disposed on the peripheral area to be connected to each of the second sub-connection wiring in one-to-one correspondence.

24-27. (canceled)

28. The capacitive touch panel of claim 15, when it is assumed that a line which is vertical to a length direction of the main sensor and passing a center area of the main sensor is an imaginary line,
the first sub-connection wiring is connected to first and second sides of a sub-sensors disposed on an upper area with respect to the imaginary line, and
the second sub-connection wiring is connected to first and second sides of sub-sensors disposed on a lower area with respect to the imaginary line.

29. The capacitive touch panel of claim 15, wherein a first side of a sub-sensor disposed on a line perpendicular to a length direction of the main sensor is connected to the first sub-connection wiring, and
a second side of a sub-sensor disposed on a line perpendicular to a length direction of the main sensor is connected to the second sub-connection wiring.

30. The capacitive touch panel of claim 29, wherein the first sub-connection wirings are disposed between a sub-sensor connected to the first sub-connection wiring and a main sensor disposed at a left side of the corresponding sub-sensor, and
the second sub-connection wirings are disposed between a sub-sensor connected to the second sub-connection wiring and a main sensor disposed at a right side of the corresponding sub-sensor.

31. A capacitive touch apparatus comprising:
a capacitive touch panel comprising a base substrate comprising a touch area and a peripheral area surrounding the base substrate, a plurality of main sensors disposed on the touch area, a plurality of sub-sensors disposed along one line adjacent to each of the main sensors, a plurality of main connection wirings connected to first side of the main sensors, respectively, and a plurality of sub-connection wirings connecting to sub-sensors disposed on an imaginary line perpendicular to a length direction of the main sensor, the sub-sensors disposed in one-to-plural correspondence with respect to one main sensor; and
a capacitance measuring circuit respectively connected to two end terminals of the main sensors and two terminals of the sub-sensors to sense a capacitance variation of the main sensors and the sub-sensors to measure a touch position,
wherein the sub-sensors disposed on an imaginary line vertical to a length direction of the main sensor are connected to each other, and
the main sensors, the sub-sensors and the sub-connection wirings are disposed to define a single layer structure.

32. The capacitive touch apparatus of claim 31, wherein the capacitance measuring circuit measures a first axis value of a touch position bases on the main sensor, and measures a second axis value of a touch position bases on the sub-sensor.

33. (canceled)

34. The capacitive touch apparatus of claim 31, wherein each sub-sensors disposed on the same row of sub-sensors serially connected to each other is connected to the different ports of a capacitance measuring circuit to sense a touch position in a self-capacitance method.

35. The capacitive touch apparatus of claim 31, wherein each sub-sensors disposed on the same row of sub-sensors serially connected to each other is commonly connected to a capacitance measuring circuit to sense a touch position in a mutual capacitance method.

36. A capacitive touch apparatus comprising:
a capacitive touch panel comprising a plurality of main sensors extended along a first direction of a touch area to be arranged along a second direction and a plurality of sub-sensors arranged along the first direction in one-to-plural correspondence in parallel with the main sensors; and
a capacitance measuring circuit respectively connected to two end terminals of the main sensors and two terminals of the sub-sensors to sense a capacitance variation of the main sensors and the sub-sensors to measure a touch position,
wherein the main sensor and the sub-sensors arranged in parallel with the main sensor are alternately arranged.

37. The capacitive touch apparatus of claim 36, wherein the capacitance measuring circuit measures a first axis value of a touch position bases on the main sensor, and measures a second axis value of a touch position bases on the sub-sensor.

38. (canceled)

39. (canceled)

40. The capacitive touch apparatus of claim 36, wherein the capacitive touch panel further comprises:
a plurality of main connection wirings connected to first sides of the main sensors, respectively;
a plurality of second main-connection wirings connected to second sides of the main sensors, respectively;
a plurality of first sub-connection wirings connected to a portion of sub-sensors arranged along the first direction and extended along an upper direction when viewed from a plan view; and
a plurality of second sub-connection wirings connected to a portion of sub-sensors or the remaining sub-sensors and extended along a lower direction when viewed from a plan view.

41. The capacitive touch apparatus of claim 36, wherein the capacitive touch panel further comprises:
a plurality of first sub-bypass wirings disposed on a peripheral area surrounding the touch area to be connected to each of the first sub-connection wiring in one-to-one correspondence; and
a plurality of second sub-bypass wirings disposed on the peripheral area to be connected to each of the second sub-connection wiring in one-to-one correspondence.
